(19) United States
(12) Patent Application Publication
(10) Pub. No.: US 2019/0079526 A1
(43) Pub. Date: Mar. 14, 2019

(54) Orientation Determination in Object Detection and Tracking for Autonomous Vehicles

(71) Applicant: Uber Technologies, Inc., San Francisco, CA (US)

(72) Inventors: Carlos Vallespi-Gonzalez, Pittsburgh, PA (US); Abhishek Sen, Pittsburgh, PA (US); Wei Pu, Pittsburgh, PA (US); Joseph Pilarczyk, II, Pittsburgh, PA (US)

(21) Appl. No.: 15/795,632

(22) Filed: Oct. 27, 2017

Related U.S. Application Data
(60) Provisional application No. 62/555,816, filed on Sep. 8, 2017.

(51) Int. Cl. G05D 1/02; G06K 9/00; G01S 13/93; G01S 15/93; G01S 17/93; G01S 7/48; G06N 99/00

(52) U.S. Cl. CPC G05D 1/0221; G06K 9/00805; G05D 1/0231; G05D 1/0257; G05D 1/0255; G05D 2201/0213; G01S 15/931; G01S 17/936; G01S 7/4802; G06N 99/005; G01S 13/931

(57) ABSTRACT

Systems, methods, tangible non-transitory computer-readable media, and devices for operating an autonomous vehicle are provided. For example, a method can include receiving object data based on one or more states of one or more objects. The object data can include information based on sensor output associated with one or more portions of the one or more objects. Characteristics of the one or more objects, including an estimated set of physical dimensions of the one or more objects can be determined, based in part on the object data and a machine learned model. One or more orientations of the one or more objects relative to the location of the autonomous vehicle can be determined based on the estimated set of physical dimensions of the one or more objects. Vehicle systems associated with the autonomous vehicle can be activated, based on the one or more orientations of the one or more objects.

### RELATED APPLICATION

The present application claims the benefit of U.S. Provisional Patent Application No. 62/555,816 filed, on Sep. 8, 2017, which is hereby incorporated by reference in its entirety.

### FIELD

The present disclosure relates generally to operation of an autonomous vehicle including the determination of one or more characteristics of a detected object through use of machine learned classifiers.

### BACKGROUND

Vehicles, including autonomous vehicles, can receive sensor data based on the state of the environment through which the vehicle travels. The sensor data can be used to determine the state of the environment around the vehicle. However, the environment through which the vehicle travels is subject to change as are the objects that are in the environment during any given time period. Further, the vehicle travels through a variety of different environments, which can impose different demands on the vehicle in order to maintain an acceptable level of safety. Accordingly, there exists a need for an autonomous vehicle that is able to more effectively and safely navigate a variety of different environments.

### SUMMARY

Aspects and advantages of embodiments of the present disclosure will be set forth in part in the following description, or may be learned from the description, or may be learned through practice of the embodiments.

An example aspect of the present disclosure is directed to a computer-implemented method of operating an autonomous vehicle. The computer-implemented method of operating an autonomous vehicle can include receiving, by a computing system comprising one or more computing devices, object data based in part on one or more states of one or more objects. The object data can include information based in part on sensor output associated with one or more portions of the one or more objects that is detected by one or more sensors of the autonomous vehicle. The method can also include, determining, by the computing system, based in part on the object data and a machine learned model, one or more characteristics of the one or more objects. The one or more characteristics can include an estimated set of physical dimensions of the one or more objects. The method can also include, determining, by the computing system, based in part on the estimated set of physical dimensions of the one or more objects, one or more orientations corresponding to the one or more objects. The one or more orientations can be relative to the location of the autonomous vehicle. The method can also include, activating, by the computing system, based in part on the one or more orientations of the one or more objects, one or more vehicle systems associated with the autonomous vehicle.

Another example aspect of the present disclosure is directed to one or more tangible, non-transitory computer-readable media storing computer-readable instructions that when executed by one or more processors cause the one or more processors to perform operations. The operations can include receiving object data based in part on one or more states of one or more objects. The object data can include information based in part on sensor output associated with one or more portions of the one or more objects that is detected by one or more sensors of the autonomous vehicle. The operations can also include determining, based in part on the object data and a machine learned model, one or more characteristics of the one or more objects. The one or more characteristics can include an estimated set of physical dimensions of the one or more objects. The operations can also include determining, based in part on the estimated set of physical dimensions of the one or more objects, one or more orientations corresponding to the one or more objects. The one or more orientations can be relative to the location of the autonomous vehicle. The operations can also include activating, based in part on the one or more orientations of the one or more objects, one or more vehicle systems associated with the autonomous vehicle.

Another example aspect of the present disclosure is directed to a computing system comprising one or more processors and one or more non-transitory computer-readable media storing instructions that when executed by the one or more processors cause the one or more processors to perform operations. The operations can include receiving object data based in part on one or more states of one or more objects. The object data can include information based in part on sensor output associated with one or more portions of the one or more objects that is detected by one or more sensors of the autonomous vehicle. The operations can also include determining, based in part on the object data and a machine learned model, one or more characteristics of the one or more objects. The one or more characteristics can include an estimated set of physical dimensions of the one or more objects. The operations can also include determining, based in part on the estimated set of physical dimensions of the one or more objects, one or more orientations corresponding to the one or more objects. The one or more orientations can be relative to the location of the autonomous vehicle. The operations can also include activating, based in part on the one or more orientations of the one or more objects, one or more vehicle systems associated with the autonomous vehicle.

Other example aspects of the present disclosure are directed to other systems, methods, vehicles, apparatuses, tangible non-transitory computer-readable media, and/or devices for operation of an autonomous vehicle including determination of physical dimensions and/or orientations of one or more objects.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a diagram of an example system according to example embodiments of the present disclosure;

FIG. 2 depicts an example of detecting an object and determining the object's orientation according to example embodiments of the present disclosure;

FIG. 3 depicts an example of detecting an object and determining the object's orientation according to example embodiments of the present disclosure;

FIG. 4 depicts an example of detecting an object and determining the object's orientation according to example embodiments of the present disclosure;

FIG. 5 depicts an example of an environment including a plurality of detected objects according to example embodiments of the present disclosure;

FIG. 6 depicts an example of an environment including a plurality of detected objects according to example embodiments of the present disclosure;

FIG. 7 depicts an example of an environment including a plurality of partially occluded objects according to example embodiments of the present disclosure;

FIG. 8 depicts a flow diagram of an example method of determining object orientation according to example embodiments of the present disclosure;

FIG. 9 depicts a flow diagram of an example method of determining bounding shapes according to example embodiments of the present disclosure; and

FIG. 10 depicts a diagram of an example system according to example embodiments of the present disclosure.

### DETAILED DESCRIPTION

Example aspects of the present disclosure are directed at detecting and tracking one or more objects (e.g., vehicles, pedestrians, and/or cyclists) in an environment proximate (e.g., within a predetermined distance) to a vehicle (e.g., an autonomous vehicle, a semi-autonomous vehicle, or a manually operated vehicle), and through use of sensor output (e.g., light detection and ranging device output, sonar output, radar output, and/or camera output) and a machine learned model, determining one or more characteristics of the one or more objects. More particularly, aspects of the present disclosure include determining an estimated set of physical dimensions of the one or more objects (e.g., physical dimensions including an estimated length, width, and height) and one or more orientations (e.g., one or more headings, directions, and/or bearings) of the one or more objects associated with a vehicle (e.g., within range of an autonomous vehicle's sensors) based on one or more states (e.g., the location, position, and/or physical dimensions) of the one or more objects including portions of the one or more objects that are not detected by sensors of the vehicle. The vehicle can receive data including object data associated with one or more states (e.g., physical dimensions including length, width, and/or height) of one or more objects and based in part on the object data and through use of a machine learned model (e.g., a model trained to classify one or more aspects of detected objects), the vehicle can determine one or more characteristics of the one or more objects including one or more orientations of the one or more objects. In some embodiments, one or more vehicle systems (e.g., propulsion systems, braking systems, and/or steering systems) can be activated in response to the determined orientations of the one or more objects. Further, the orientations of the one or more objects can be used to determine other aspects of the one or more objects including predicted paths of detected objects and/or vehicle motion plans for vehicle navigation relative to the detected objects.

As such, the disclosed technology can better determine the physical dimensions and orientation of objects in proximity to a vehicle. In particular, by enabling more effective determination of object dimensions and orientations, the disclosed technology allows for safer vehicle operation through improved object avoidance and situational awareness with respect to objects that are oriented on a path that will intersect the path of the autonomous vehicle.

By way of example, the vehicle can receive object data from one or more sensors on the vehicle (e.g., one or more cameras, microphones, radar, thermal imaging devices, and/or sonar.) In some embodiments, the object data can include light detection and ranging (LIDAR) data associated with the three-dimensional positions or locations of objects detected by a LIDAR system. The vehicle can also access (e.g., access local data or retrieve data from a remote source) a machine learned model that is based on classified features associated with classified training objects (e.g., training sets of pedestrians, vehicles, and/or cyclists, that have had their features extracted, and have been classified accordingly). The vehicle can use any combination of the object data and/or the machine learned model to determine physical dimensions and/or orientations that correspond to the objects (e.g., the dimensions or orientations of other vehicles within a predetermined area). The orientations of the objects can be used in part to determine when objects have a trajectory that will intercept the vehicle as the object travels along its trajectory. Based on the orientations of the objects, the vehicle can change its course or increase/reduce its velocity so that the vehicle and the objects can safely navigate around each another.

The vehicle can include one or more systems including a vehicle computing system (e.g., a computing system including one or more computing devices with one or more processors and a memory) and/or a vehicle control system that can control a variety of vehicle systems and vehicle components. The vehicle computing system can process, generate, or exchange (e.g., send or receive) signals or data, including signals or data exchanged with various vehicle systems, vehicle components, other vehicles, or remote computing systems.

For example, the vehicle computing system can exchange signals (e.g., electronic signals) or data with vehicle systems including sensor systems (e.g., sensors that generate output based on the state of the physical environment external to the vehicle, including LIDAR, cameras, microphones, radar, or sonar); communication systems (e.g., wired or wireless communication systems that can exchange signals or data with other devices); navigation systems (e.g., devices that can receive signals from GPS, GLONASS, or other systems used to determine a vehicle's geographical location); notification systems (e.g., devices used to provide notifications to pedestrians, cyclists, and vehicles, including display devices, status indicator lights, or audio output systems); braking systems (e.g., brakes of the vehicle including mechanical and/or electric brakes); propulsion systems (e.g., motors or engines including electric engines or internal combustion engines); and/or steering systems used to change the path, course, or direction of travel of the vehicle.

The vehicle computing system can access a machine learned model that has been generated and/or trained in part using classifier data including a plurality of classified features and a plurality of classified object labels associated with training data that can be based on, or associated with, a plurality of training objects (e.g., actual physical or simulated objects used as inputs to train the machine learned model). In some embodiments, the plurality of classified features can be extracted from point cloud data that includes a plurality of three-dimensional points associated with sensor output including optical sensor output from one or more optical sensor devices (e.g., cameras and/or LIDAR devices).

When the machine learned model has been trained, the machine learned model can associate the plurality of classified features with one or more object classifier labels that are used to classify or categorize objects including objects apart from (e.g., not included in) the plurality of training objects. In some embodiments, as part of the process of training the machine learned model, the differences in correct classification output between a machine learned model (that outputs the one or more objects classification labels) and a set of classified object labels associated with a plurality of training objects that have previously been correctly identified, can be processed using an error loss function (e.g., a cross entropy function) that can determine a set of probability distributions based on the same plurality of training objects. Accordingly, the performance of the machine learned model can be optimized over time.

The vehicle computing system can access the machine learned model in various ways including exchanging (sending or receiving via a network) data or information associated with a machine learned model that is stored on a remote computing device; or accessing a machine learned model that is stored locally (e.g., in a storage device onboard the vehicle).

The plurality of classified features can be associated with one or more values that can be analyzed individually or in aggregate. The analysis of the one or more values associated with the plurality of classified features can include determining a mean, mode, median, variance, standard deviation, maximum, minimum, and/or frequency of the one or more values associated with the plurality of classified features. Further, the analysis of the one or more values associated with the plurality of classified features can include comparisons of the differences or similarities between the one or more values. For example, vehicles can be associated with a maximum velocity value or minimum size value that is different from the maximum velocity value or minimum size value associated with a cyclist or pedestrian.

In some embodiments, the plurality of classified features can include a range of velocities associated with the plurality of training objects, a range of accelerations associated with the plurality of training objects, a length of the plurality of training objects, a width of the plurality of training objects, and/or a height of the plurality of training objects. The plurality of classified features can be based in part on the output from one or more sensors that have captured a plurality of training objects (e.g., actual objects used to train the machine learned model) from various angles and/or distances in different environments (e.g., urban areas, suburban areas, rural areas, heavy traffic, and/or light traffic) and/or environmental conditions (e.g., bright daylight, overcast daylight, darkness, wet reflective roads, in parking structures, in tunnels, and/or under streetlights). The one or more classified object labels, which can be used to classify or categorize the one or more objects, can include buildings, roadways, bridges, waterways, pedestrians, vehicles, or cyclists.

In some embodiments, the classifier data can be based in part on a plurality of classified features extracted from sensor data associated with output from one or more sensors associated with a plurality of training objects (e.g., previously classified pedestrians, vehicles, and cyclists). The sensors used to obtain sensor data from which features can be extracted can include one or more light detection and ranging devices (LIDAR), one or more radar devices, one or more sonar devices, and/or one or more cameras.

The machine learned model can be generated based in part on one or more classification processes or classification techniques. The one or more classification processes or classification techniques can include one or more computing processes performed by one or more computing devices based in part on object data associated with physical outputs from a sensor device. The one or more computing processes can include the classification (e.g., allocation or sorting into different groups or categories) of the physical outputs from the sensor device, based in part on one or more classification criteria (e.g., a size, shape, velocity, or acceleration associated with an object).

The machine learned model can compare the object data to the classifier data based in part on sensor outputs captured from the detection of one or more classified objects (e.g., thousands or millions of objects) in a variety of environments or conditions. Based on the comparison, the vehicle computing system can determine one or more characteristics of the one or more objects. The one or more characteristics can be mapped to, or associated with, one or more classes based in part on one or more classification criteria. For example, one or more classification criteria can distinguish an automobile class from a cyclist class based in part on their respective sets of features. The automobile class can be associated with one set of velocity features (e.g., a velocity range of zero to three hundred kilometers per hour) and size features (e.g., a size range of five cubic meters to twenty-five cubic meters) and a cyclist class can be associated with a different set of velocity features (e.g., a velocity range of zero to forty kilometers per hour) and size features (e.g., a size range of half a cubic meter to two cubic meters).

The vehicle computing system can receive object data based in part on one or more states or conditions of one or more objects. The one or more objects can include any object external to the vehicle including one or more pedestrians (e.g., one or more persons standing, sitting, walking, or running), one or more other vehicles (e.g., automobiles, trucks, buses, motorcycles, mopeds, aircraft, boats, amphibious vehicles, and/or trains), one or more cyclists (e.g., persons sitting or riding on bicycles). Further, the object data can be based in part on one or more states of the one or more objects including physical properties or characteristics of the one or more objects. The one or more states associated with the one or more objects can include the shape, texture, velocity, acceleration, and/or physical dimensions (e.g., length, width, and/or height) of the one or more objects or portions of the one or more objects (e.g., a side of the one or more objects that is facing the vehicle).

In some embodiments, the object data can include a set of three-dimensional points (e.g., x, y, and z coordinates) associated with one or more physical dimensions (e.g., the length, width, and/or height) of the one or more objects, one or more locations (e.g., geographical locations) of the one or more objects, and/or one or more relative locations of the one or more objects relative to a point of reference (e.g., the location of a portion of the autonomous vehicle). In some embodiments, the object data can be based on outputs from a variety of devices or systems including vehicle systems (e.g., sensor systems of the vehicle) or systems external to the vehicle including remote sensor systems (e.g., sensor systems on traffic lights, roads, or sensor systems on other vehicles).

The vehicle computing system can receive one or more sensor outputs from one or more sensors of the autonomous vehicle. The one or more sensors can be configured to detect a plurality of three-dimensional positions or locations of surfaces (e.g., the x, y, and z coordinates of the surface of a motor vehicle based in part on a reflected laser pulse from a LIDAR device of the vehicle) of the one or more objects. The one or more sensors can detect the state (e.g., physical characteristics or properties, including dimensions) of the environment or one or more objects external to the vehicle and can include one or more light detection and ranging (LIDAR) devices, one or more radar devices, one or more sonar devices, and/or one or more cameras. In some embodiments, the object data can be based in part on the output from one or more vehicle systems (e.g., systems that are part of the vehicle) including the sensor output (e.g., one or more three-dimensional points associated with the plurality of three-dimensional positions of the surfaces of one or more objects) from the one or more sensors. The object data can include information that is based in part on sensor output associated with one or more portions of the one or more objects that are detected by one or more sensors of the autonomous vehicle.

The vehicle computing system can determine, based in part on the object data and a machine learned model, one or more characteristics of the one or more objects. The one or more characteristics of the one or more objects can include the properties or qualities of the object data including the shape, texture, velocity, acceleration, and/or physical dimensions (e.g., length, width, and/or height) of the one or more objects and/or portions of the one or more objects (e.g., a portion of an object that is blocked by another object). Further, the one or more characteristics of the one or more objects can include an estimated set of physical dimensions of one or more objects (e.g., an estimated set of physical dimensions based in part on the one or more portions of the one or more objects that are detected by the one or more sensors of the vehicle). For example, the vehicle computing system can use the one or more sensors to detect a rear portion of a truck and estimate the physical dimensions of the truck based on the physical dimensions of the detected rear portion of the truck. Further, the one or more characteristics can include properties or qualities of the object data that can be determined or inferred from the object data including volume (e.g., using the size of a portion of an object to determine a volume) or shape (e.g., mirroring one side of an object that is not detected by the one or more sensors to match the side that is detected by the one or more sensors).

The vehicle computing system can determine the one or more characteristics of the one or more objects by applying the object data to the machine learned model. The one or more sensor devices can include LIDAR devices that can determine the shape of an object based in part on object data that is based on the physical inputs to the LIDAR devices (e.g., the laser pulses reflected from the object) when one or more objects are detected by the LIDAR devices.

In some embodiments, vehicle computing system can determine, for each of the one or more objects, based in part on a comparison of the one or more characteristics of the one or more objects to the plurality of classified features associated with the plurality of training objects, one or more shapes corresponding to the one or more objects. For example, the vehicle computing system can determine that an object is a pedestrian based on a comparison of the one or more characteristics of the object (e.g., the size and velocity of the pedestrian) to the plurality of training objects which includes classified pedestrians of various sizes, shapes, and velocities. The one or more shapes corresponding to the one or more objects can be used to determine sides of the one or more objects including a front-side, a rear-side (e.g., back-side), a left-side, a right-side, a top-side, or a bottom-side, of the one or more objects. The spatial relationship between the sides of the one or more objects can be used to determine the one or more orientations of the one or more objects. For example, the longer sides of an automobile (e.g., the sides with doors parallel to the direction of travel and through which passengers enter or exit the automobile) can be an indication of the axis along which the automobile is oriented. As such, the one or more orientations of the one or more objects can be based in part on the one or more shapes of the one or more objects.

In some embodiments, based on the one or more characteristics, the vehicle computing system can classify the object data based in part on the extent to which the newly received object data corresponds to the features associated with the one or more classes. In some embodiments, the one or more classification processes or classification techniques can be based in part on a random forest classifier, gradient boosting, a neural network, a support vector machine, a logistic regression classifier, or a boosted forest classifier.

The vehicle computing system can determine, based in part on the one or more characteristics of the one or more objects, including the estimated set of physical dimensions, one or more orientations that, in some embodiments, can correspond to the one or more objects. For example, the one or more characteristics of the one or more objects can indicate one or more orientations of the one or more objects based on the velocity and direction of travel of the one or more objects, and/or a shape of a portion of the one or more objects (e.g., the shape of a rear bumper of an automobile). The one or more orientations of the one or more objects can be relative to a point of reference including a compass orientation (e.g., an orientation relative to the geographic or magnetic north pole or south pole), relative to a point of fixed point of reference (e.g., a geographic landmark), and/or relative to the location of the autonomous vehicle.

In some embodiments, the vehicle computing system can determine, based in part on the object data, one or more locations of the one or more objects over a predetermined time period or time interval (e.g., a time interval between two chronological times of day or a time period of a set duration). The one or more locations of the one or more objects can include geographic locations or positions (e.g., the latitude and longitude of the one or more objects) and/or the location of the one or more objects relative to a point of reference (e.g., a portion of the vehicle).

Further, the vehicle computing system can determine one or more travel paths for the one or more objects based in part on changes in the one or more locations of the one or more objects over the predetermined time interval or time period. A travel path for an object can include the portion of the travel path that the object has traversed over the predetermined time interval or time period and a portion of the travel path that the object is determined to traverse at subsequent time intervals or time periods, based on the shape of the portion of the travel path that the object has traversed. The one or more orientations of the one or more objects can be based in part on the one or more travel paths. For example, the shape of the travel path at a specified time interval or time period can correspond to the orientation of the object during that specified time interval or time period.

The vehicle computing system can activate, based in part on the one or more orientations of the one or more objects, one or more vehicle systems of the autonomous vehicle. For example, the vehicle computing system can activate one or more vehicle systems including one or more notification systems that can generate warning indications (e.g., lights or sounds) when the one or more orientations of the one or more objects are determined to intersect the vehicle within a predetermined time period; braking systems that can be used to slow the vehicle when the orientations of the one or more objects are determined to intersect a travel path of the vehicle within a predetermined time period; propulsion systems that can change the acceleration or velocity of the vehicle; and/or steering systems that can change the path, course, and/or direction of travel of the vehicle.

In some embodiments, the vehicle computing system can determine, based in part on the one or more travel paths of the one or more objects, a vehicle travel path for the autonomous vehicle in which the autonomous vehicle does not intersect the one or more objects. The vehicle travel path can include a path or course that the vehicle can follow so that the vehicle will not come into contact with any of the one or more objects. The activation of the one or more vehicle systems associated with the autonomous vehicle can be based in part on the vehicle travel path.

The vehicle computing system can generate, based in part on the object data, one or more bounding shapes (e.g., two-dimensional or three dimensional bounding polygons or bounding boxes) that can surround one or more areas/volumes associated with the one or more physical dimensions or the estimated set of physical dimensions of the one or more objects. The one or more bounding shapes can include one or more polygons that surround a portion of the one or more objects. For example, the one or more bounding shapes can surround the one or more objects that are detected by a camera onboard the vehicle.

In some embodiments, the one or more orientations of the one or more objects can be based in part on characteristics of the one or more bounding shapes including a length, a width, a height, or a center-point associated with the one or more bounding shapes. For example, the vehicle computing system can determine that the longest side of an object is the length of the object (e.g., the distance from the front portion of a vehicle to the rear portion of a vehicle). Based in part on the determination of the length of the object, the vehicle computing system can determine the orientation for the object based on the position of the rear portion of the vehicle relative to the forward portion of the vehicle.

In some embodiments, the vehicle computing system can determine, based in part on the object data or the machine learned model, one or more portions of the one or more objects that are occluded (e.g., blocked or obstructed from detection by the one or more sensors of the autonomous vehicle). In some embodiments, the estimated set of physical dimensions for the one or more objects can be based in part on the one or more portions of the one or more objects that are not occluded (e.g., occluded from detection by the one or more sensors) by at least one other object of the one or more objects. Based on a classification of a portion of an object that is detected by the one or more sensors as corresponding to a previously classified object, the physical dimensions of the previously classified object can be mapped onto the portion of the object that is partly visible to the one or more sensors and used as the estimated set of physical dimensions. For example, the one or more sensors can detect a rear portion of a vehicle that is occluded by another vehicle or a portion of a building. Based on the portion of the vehicle that is detected, the vehicle computing system can determine the physical dimensions of the rest of the vehicle. In some embodiments, the one or more bounding shapes can be based in part on the estimated set of physical dimensions.

The systems, methods, and devices in the disclosed technology can provide a variety of technical effects and benefits to the overall operation of the vehicle and the determination of the orientations, shapes, dimensions, or other characteristics of objects around the vehicle in particular. The disclosed technology can more effectively determine characteristics including orientations, shapes, and/or dimensions for objects through use of a machine learned model that allows such object characteristics to be determined more rapidly and with greater precision and accuracy. By utilizing a machine learned model, object characteristic determination can provide accuracy enhancements over a rules-based determination system. Example systems in accordance with the disclosed technology can achieve significantly improved average orientation error and a reduction in the number of orientation outliers (e.g., the number of times in which the difference between predicted orientation and actual orientation is greater than some threshold value). Moreover, the machine learned model can be more easily adjusted (e.g., via re-fined training) than a rules-based system (e.g., requiring re-written rules) as the vehicle computing system is periodically updated to calculate advanced object features. This can allow for more efficient upgrading of the vehicle computing system, leading to less vehicle downtime.

The systems, methods, and devices in the disclosed technology have an additional technical effect and benefit of improved scalability by using a machine learned model to determine object characteristics including orientation, shape, and/or dimensions. In particular, modeling object characteristics through machine learned models greatly reduces the research time needed relative to development of hand-crafted object characteristic determination rules. For example, for hand-crafted object characteristic rules, a designer would need to exhaustively derive heuristic models of how different objects may have different characteristics in different scenarios. It can be difficult to create hand-crafted rules that effectively address all possible scenarios that an autonomous vehicle may encounter relative to vehicles and other detected objects. By contrast, the disclosed technology, through use of machine learned models as described herein, can train a model on training data, which can be done at a scale proportional to the available resources of the training system (e.g., a massive scale of training data can be used to train the machine learned model). Further, the machine learned models can easily be revised as new training data is made available. As such, use of a machine learned model trained on labeled object data can provide a scalable and customizable solution.

Further, the systems, methods, and devices in the disclosed technology have an additional technical effect and benefit of improved adaptability and opportunity to realize improvements in related autonomy systems by using a machine learned model to determine object characteristics (e.g., orientation, shape, dimensions) for detected objects. An autonomy system can include numerous different components (e.g., perception, prediction, and/or optimization) that jointly operate to determine a vehicle's motion plan. As technology improvements to one component are introduced, a machine learned model can capitalize on those improvements to create a more refined and accurate determination of object characteristics, for example, by simply retraining the existing model on new training data captured by the improved autonomy components. Such improved object characteristic determinations may be more easily recognized by a machine learned model as opposed to hand-crafted algorithms.

As such, the superior determinations of object characteristics (e.g., orientations, headings, object shapes, or physical dimensions) allow for an improvement in safety for both passengers inside the vehicle as well as those outside the vehicle (e.g., pedestrians, cyclists, and other vehicles). For example, the disclosed technology can more effectively avoid coming into unintended contact with objects (e.g., by steering the vehicle away from the path associated with the object orientation) through improved determination of the orientations of the objects. Further, the disclosed technology can activate notification systems to notify pedestrians, cyclists, and other vehicles of their respective orientations with respect to the autonomous vehicle. For example, the autonomous vehicle can activate a horn or light that can notify pedestrians, cyclists, and other vehicles of the presence of the autonomous vehicle.

The disclosed technology can also improve the operation of the vehicle by reducing the amount of wear and tear on vehicle components through more gradual adjustments in the vehicle's travel path that can be performed based on the improved orientation information associated with objects in the vehicle's environment. For example, earlier and more accurate and precise determination of the orientations of objects can result in a less jarring ride (e.g., fewer sharp course corrections) that puts less strain on the vehicle's engine, braking, and steering systems. Additionally, smoother adjustments by the vehicle (e.g., more gradual turns and changes in velocity) can result in improved passenger comfort when the vehicle is in transit.

Accordingly, the disclosed technology provides more determination of object orientations along with operational benefits including enhanced vehicle safety through better object avoidance and object notification, as well as a reduction in wear and tear on vehicle components through less jarring vehicle navigation based on more accurate and precise object orientations.

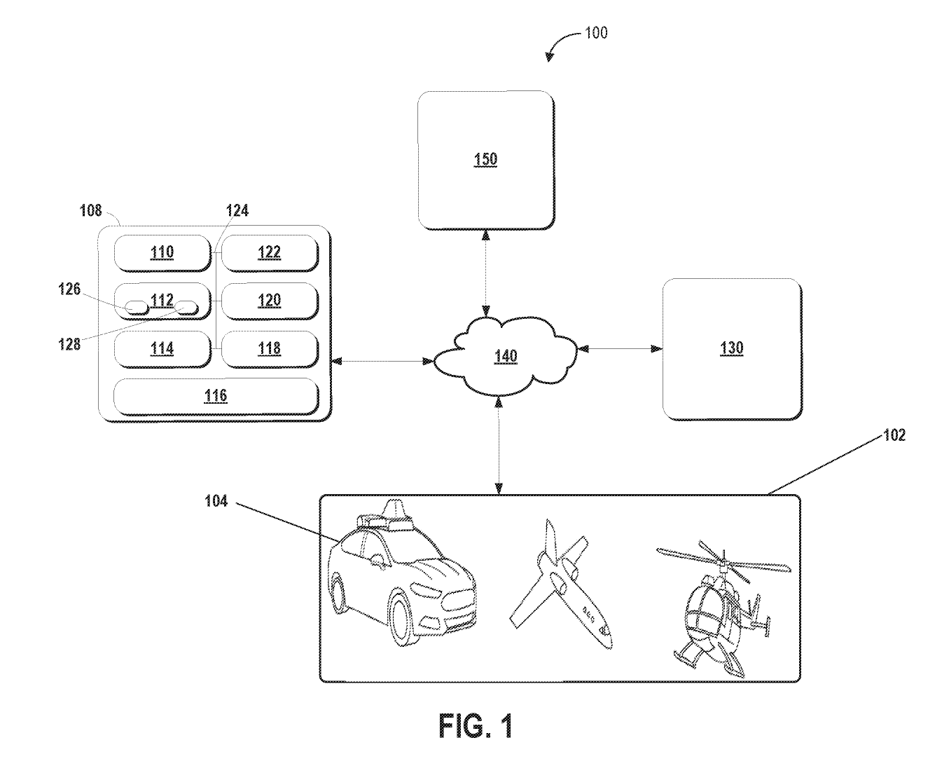

With reference now to FIGS. 1-10, example embodiments of the present disclosure will be discussed in further detail. FIG. 1 depicts a diagram of an example system 100 according to example embodiments of the present disclosure. The system 100 can include a plurality of vehicles 102; a vehicle 104; a vehicle computing system 108 that includes one or more computing devices 110; one or more data acquisition systems 112; an autonomy system 114; one or more control systems 116; one or more human machine interface systems 118; other vehicle systems 120; a communications system 122; a network 124; one or more image capture devices 126; one or more sensors 128; one or more remote computing devices 130; a communication network 140; and an operations computing system 150.

The operations computing system 150 can be associated with a service provider that provides one or more vehicle services to a plurality of users via a fleet of vehicles that includes, for example, the vehicle 104. The vehicle services can include transportation services (e.g., rideshare services), courier services, delivery services, and/or other types of services.

The operations computing system 150 can include multiple components for performing various operations and functions. For example, the operations computing system 150 can include and/or otherwise be associated with one or more remote computing devices that are remote from the vehicle 104. The one or more remote computing devices can include one or more processors and one or more memory devices. The one or more memory devices can store instructions that when executed by the one or more processors cause the one or more processors to perform operations and functions associated with operation of the vehicle including determination of the state of one or more objects including the determination of the physical dimensions and/or orientation of the one or more objects.

For example, the operations computing system 150 can be configured to monitor and communicate with the vehicle 104 and/or its users to coordinate a vehicle service provided by the vehicle 104. To do so, the operations computing system 150 can manage a database that includes data including vehicle status data associated with the status of vehicles including the vehicle 104. The vehicle status data can include a location of the plurality of vehicles 102 (e.g., a latitude and longitude of a vehicle), the availability of a vehicle (e.g., whether a vehicle is available to pick-up or drop-off passengers or cargo), or the state of objects external to the vehicle (e.g., the physical dimensions and orientation of objects external to the vehicle).

An indication, record, and/or other data indicative of the state of the one or more objects, including the physical dimensions or orientation of the one or more objects, can be stored locally in one or more memory devices of the vehicle 104. Furthermore, the vehicle 104 can provide data indicative of the state of the one or more objects (e.g., physical dimensions or orientations of the one or more objects) within a predefined distance of the vehicle 104 to the operations computing system 150, which can store an indication, record, and/or other data indicative of the state of the one or more objects within a predefined distance of the vehicle 104 in one or more memory devices associated with the operations computing system 150 (e.g., remote from the vehicle).

The operations computing system 150 can communicate with the vehicle 104 via one or more communications networks including the communications network 140. The communications network 140 can exchange (send or receive) signals (e.g., electronic signals) or data (e.g., data from a computing device) and include any combination of various wired (e.g., twisted pair cable) and/or wireless communication mechanisms (e.g., cellular, wireless, satellite, microwave, and radio frequency) and/or any desired network topology (or topologies). For example, the communications network 140 can include a local area network (e.g. intranet), wide area network (e.g. Internet), wireless LAN network (e.g., via Wi-Fi), cellular network, a SATCOM network, VHF network, a HF network, a WiMAX based network, and/or any other suitable communications network (or combination thereof) for transmitting data to and/or from the vehicle 104.

The vehicle 104 can be a ground-based vehicle (e.g., an automobile), an aircraft, and/or another type of vehicle. The vehicle 104 can be an autonomous vehicle that can perform various actions including driving, navigating, and/or operating, with minimal and/or no interaction from a human driver. The autonomous vehicle 104 can be configured to operate in one or more modes including, for example, a fully autonomous operational mode, a semi-autonomous operational mode, a park mode, and/or a sleep mode. A fully autonomous (e.g., self-driving) operational mode can be one in which the vehicle 104 can provide driving and navigational operation with minimal and/or no interaction from a human driver present in the vehicle. A semi-autonomous operational mode can be one in which the vehicle 104 can operate with some interaction from a human driver present in the vehicle. Park and/or sleep modes can be used between operational modes while the vehicle 104 performs various actions including waiting to provide a subsequent vehicle service, and/or recharging between operational modes.

The vehicle 104 can include a vehicle computing system 108. The vehicle computing system 108 can include various components for performing various operations and functions. For example, the vehicle computing system 108 can include one or more computing devices 110 on-board the vehicle 104. The one or more computing devices 110 can include one or more processors and one or more memory devices, each of which are on-board the vehicle 104. The one or more memory devices can store instructions that when executed by the one or more processors cause the one or more processors to perform operations and functions, such as those taking the vehicle 104 out-of-service, stopping the motion of the vehicle 104, determining the state of one or more objects within a predefined distance of the vehicle 104, or generating indications associated with the state of one or more objects within a determined (e.g., predefined) distance of the vehicle 104, as described herein.

The one or more computing devices 110 can implement, include, and/or otherwise be associated with various other systems on-board the vehicle 104. The one or more computing devices 110 can be configured to communicate with these other on-board systems of the vehicle 104. For instance, the one or more computing devices 110 can be configured to communicate with one or more data acquisition systems 112, an autonomy system 114 (e.g., including a navigation system), one or more control systems 116, one or more human machine interface systems 118, other vehicle systems 120, and/or a communications system 122. The one or more computing devices 110 can be configured to communicate with these systems via a network 124. The network 124 can include one or more data buses (e.g., controller area network (CAN)), on-board diagnostics connector (e.g., OBD-II), and/or a combination of wired and/or wireless communication links. The one or more computing devices 110 and/or the other on-board systems can send and/or receive data, messages, and/or signals, amongst one another via the network 124.

The one or more data acquisition systems 112 can include various devices configured to acquire data associated with the vehicle 104. This can include data associated with the vehicle including one or more of the vehicle's systems (e.g., health data), the vehicle's interior, the vehicle's exterior, the vehicle's surroundings, and/or the vehicle users. The one or more data acquisition systems 112 can include, for example, one or more image capture devices 126. The one or more image capture devices 126 can include one or more cameras, LIDAR systems), two-dimensional image capture devices, three-dimensional image capture devices, static image capture devices, dynamic (e.g., rotating) image capture devices, video capture devices (e.g., video recorders), lane detectors, scanners, optical readers, electric eyes, and/or other suitable types of image capture devices. The one or more image capture devices 126 can be located in the interior and/or on the exterior of the vehicle 104. The one or more image capture devices 126 can be configured to acquire image data to be used for operation of the vehicle 104 in an autonomous mode. For example, the one or more image capture devices 126 can acquire image data to allow the vehicle 104 to implement one or more machine vision techniques (e.g., to detect objects in the surrounding environment).

Additionally, or alternatively, the one or more data acquisition systems 112 can include one or more sensors 128. The one or more sensors 128 can include impact sensors, motion sensors, pressure sensors, mass sensors, weight sensors, volume sensors (e.g., sensors that can determine the volume of an object in liters), temperature sensors, humidity sensors, RADAR, sonar, radios, medium-range and long-range sensors (e.g., for obtaining information associated with the vehicle's surroundings), global positioning system (GPS) equipment, proximity sensors, and/or any other types of sensors for obtaining data indicative of parameters associated with the vehicle 104 and/or relevant to the operation of the vehicle 104. The one or more data acquisition systems 112 can include the one or more sensors 128 dedicated to obtaining data associated with a particular aspect of the vehicle 104, including, the vehicle's fuel tank, engine, oil compartment, and/or wipers. The one or more sensors 128 can also, or alternatively, include sensors associated with one or more mechanical and/or electrical components of the vehicle 104. For example, the one or more sensors 128 can be configured to detect whether a vehicle door, trunk, and/or gas cap, is in an open or closed position. In some implementations, the data acquired by the one or more sensors 128 can help detect other vehicles and/or objects, road conditions (e.g., curves, potholes, dips, bumps, and/or changes in grade), measure a distance between the vehicle 104 and other vehicles and/or objects.

The vehicle computing system 108 can also be configured to obtain map data. For instance, a computing device of the vehicle (e.g., within the autonomy system 114) can be configured to receive map data from one or more remote computing device including the operations computing system 150 or the one or more remote computing devices 130 (e.g., associated with a geographic mapping service provider). The map data can include any combination of two-dimensional or three-dimensional geographic map data associated with the area in which the vehicle was, is, or will be travelling.

The data acquired from the one or more data acquisition systems 112, the map data, and/or other data can be stored in one or more memory devices on-board the vehicle 104. The on-board memory devices can have limited storage capacity. As such, the data stored in the one or more memory devices may need to be periodically removed, deleted, and/or downloaded to another memory device (e.g., a database of the service provider). The one or more computing devices 110 can be configured to monitor the memory devices, and/or otherwise communicate with an associated processor, to determine how much available data storage is in the one or more memory devices. Further, one or more of the other on-board systems (e.g., the autonomy system 114) can be configured to access the data stored in the one or more memory devices.

The autonomy system 114 can be configured to allow the vehicle 104 to operate in an autonomous mode. For instance, the autonomy system 114 can obtain the data associated with the vehicle 104 (e.g., acquired by the one or more data acquisition systems 112). The autonomy system 114 can also obtain the map data. The autonomy system 114 can control various functions of the vehicle 104 based, at least in part, on the acquired data associated with the vehicle 104 and/or the map data to implement the autonomous mode. For example, the autonomy system 114 can include various models to perceive road features, signage, and/or objects, people, animals, etc. based on the data acquired by the one or more data acquisition systems 112, map data, and/or other data. In some implementations, the autonomy system 114 can include machine learned models that use the data acquired by the one or more data acquisition systems 112, the map data, and/or other data to help operate the autonomous vehicle. Moreover, the acquired data can help detect other vehicles and/or objects, road conditions (e.g., curves, potholes, dips, bumps, changes in grade, or the like), measure a distance between the vehicle 104 and other vehicles or objects, etc. The autonomy system 114 can be configured to predict the position and/or movement (or lack thereof) of such elements (e.g., using one or more odometry techniques). The autonomy system 114 can be configured to plan the motion of the vehicle 104 based, at least in part, on such predictions. The autonomy system 114 can implement the planned motion to appropriately navigate the vehicle 104 with minimal or no human intervention. For instance, the autonomy system 114 can include a navigation system configured to direct the vehicle 104 to a destination location. The autonomy system 114 can regulate vehicle speed, acceleration, deceleration, steering, and/or operation of other components to operate in an autonomous mode to travel to such a destination location.

The autonomy system 114 can determine a position and/or route for the vehicle 104 in real-time and/or near real-time. For instance, using acquired data, the autonomy system 114 can calculate one or more different potential routes (e.g., every fraction of a second). The autonomy system 114 can then select which route to take and cause the vehicle 104 to navigate accordingly. By way of example, the autonomy system 114 can calculate one or more different straight paths (e.g., including some in different parts of a current lane), one or more lane-change paths, one or more turning paths, and/or one or more stopping paths. The vehicle 104 can select a path based, at last in part, on acquired data, current traffic factors, travelling conditions associated with the vehicle 104, etc. In some implementations, different weights can be applied to different criteria when selecting a path. Once selected, the autonomy system 114 can cause the vehicle 104 to travel according to the selected path.

The one or more control systems 116 of the vehicle 104 can be configured to control one or more aspects of the vehicle 104. For example, the one or more control systems 116 can control one or more access points of the vehicle 104. The one or more access points can include features such as the vehicle's door locks, trunk lock, hood lock, fuel tank access, latches, and/or other mechanical access features that can be adjusted between one or more states, positions, locations, etc. For example, the one or more control systems 116 can be configured to control an access point (e.g., door lock) to adjust the access point between a first state (e.g., lock position) and a second state (e.g., unlocked position). Additionally, or alternatively, the one or more control systems 116 can be configured to control one or more other electrical features of the vehicle 104 that can be adjusted between one or more states. For example, the one or more control systems 116 can be configured to control one or more electrical features (e.g., hazard lights, microphone) to adjust the feature between a first state (e.g., off) and a second state (e.g., on).

The one or more human machine interface systems 118 can be configured to allow interaction between a user (e.g., human), the vehicle 104 (e.g., the vehicle computing system 108), and/or a third party (e.g., an operator associated with the service provider). The one or more human machine interface systems 118 can include a variety of interfaces for the user to input and/or receive information from the vehicle computing system 108. For example, the one or more human machine interface systems 118 can include a graphical user interface, direct manipulation interface, web-based user interface, touch user interface, attentive user interface, conversational and/or voice interfaces (e.g., via text messages, chatter robot), conversational interface agent, interactive voice response (IVR) system, gesture interface, and/or other types of interfaces. The one or more human machine interface systems 118 can include one or more input devices (e.g., touchscreens, keypad, touchpad, knobs, buttons, sliders, switches, mouse, gyroscope, microphone, other hardware interfaces) configured to receive user input. The one or more human machine interfaces 118 can also include one or more output devices (e.g., display devices, speakers, lights) to receive and output data associated with the interfaces.

The other vehicle systems 120 can be configured to control and/or monitor other aspects of the vehicle 104. For instance, the other vehicle systems 120 can include software update monitors, an engine control unit, transmission control unit, the on-board memory devices, etc. The one or more computing devices 110 can be configured to communicate with the other vehicle systems 120 to receive data and/or to send to one or more signals. By way of example, the software update monitors can provide, to the one or more computing devices 110, data indicative of a current status of the software running on one or more of the on-board systems and/or whether the respective system requires a software update.

The communications system 122 can be configured to allow the vehicle computing system 108 (and its one or more computing devices 110) to communicate with other computing devices. In some implementations, the vehicle computing system 108 can use the communications system 122 to communicate with one or more user devices over the networks. In some implementations, the communications system 122 can allow the one or more computing devices 110 to communicate with one or more of the systems on-board the vehicle 104. The vehicle computing system 108 can use the communications system 122 to communicate with the operations computing system 150 and/or the one or more remote computing devices 130 over the networks (e.g., via one or more wireless signal connections). The communications system 122 can include any suitable components for interfacing with one or more networks, including for example, transmitters, receivers, ports, controllers, antennas, or other suitable components that can help facilitate communication with one or more remote computing devices that are remote from the vehicle 104.

In some implementations, the one or more computing devices 110 on-board the vehicle 104 can obtain vehicle data indicative of one or more parameters associated with the vehicle 104. The one or more parameters can include information, such as health and maintenance information, associated with the vehicle 104, the vehicle computing system 108, one or more of the on-board systems, etc. For example, the one or more parameters can include fuel level, engine conditions, tire pressure, conditions associated with the vehicle's interior, conditions associated with the vehicle's exterior, mileage, time until next maintenance, time since last maintenance, available data storage in the on-board memory devices, a charge level of an energy storage device in the vehicle 104, current software status, needed software updates, and/or other heath and maintenance data of the vehicle 104.

At least a portion of the vehicle data indicative of the parameters can be provided via one or more of the systems on-board the vehicle 104. The one or more computing devices 110 can be configured to request the vehicle data from the on-board systems on a scheduled and/or as-needed basis. In some implementations, one or more of the on-board systems can be configured to provide vehicle data indicative of one or more parameters to the one or more computing devices 110 (e.g., periodically, continuously, as-needed, as requested). By way of example, the one or more data acquisitions systems 112 can provide a parameter indicative of the vehicle's fuel level and/or the charge level in a vehicle energy storage device. In some implementations, one or more of the parameters can be indicative of user input. For example, the one or more human machine interfaces 118 can receive user input (e.g., via a user interface displayed on a display device in the vehicle's interior). The one or more human machine interfaces 118 can provide data indicative of the user input to the one or more computing devices 110. In some implementations, the one or more computing devices 130 can receive input and can provide data indicative of the user input to the one or more computing devices 110. The one or more computing devices 110 can obtain the data indicative of the user input from the one or more computing devices 130 (e.g., via a wireless communication).

The one or more computing devices 110 can be configured to determine the state of the vehicle 104 and the environment around the vehicle 104 including the state of one or more objects external to the vehicle including pedestrians, cyclists, motor vehicles (e.g., trucks, and/or automobiles), roads, bodies of water (e.g., waterways), geographic features (e.g., hills, mountains, desert, plains), and/or buildings. Further, the one or more computing devices 110 can be configured to determine one or more physical characteristics of the one or more objects including physical dimensions of the one or more objects (e.g., shape, length, width, and/or height of the one or more objects). The one or more computing devices 110 can determine an estimated set of physical dimensions and/or orientations of the one or more objects, including portions of the one or more objects that are not detected by the one or more sensors 128, through use of a machine learned model that is based on a plurality of classified features and classified object labels associated with training data.

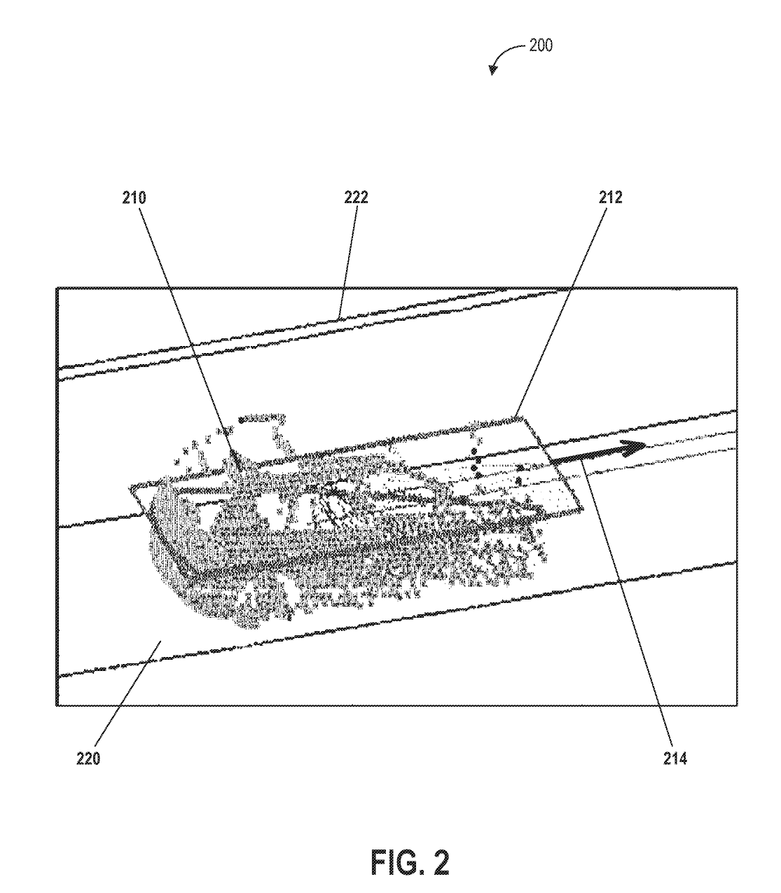

FIG. 2 depicts an example of detecting an object and determining the object's orientation according to example embodiments of the present disclosure. One or more portions of the environment 200 can be detected and processed by one or more devices (e.g., one or more computing devices) or systems including, for example, the vehicle 104, the vehicle computing system 108, and/or the operations computing system 150 that are shown in FIG. 1. Moreover, the detection and processing of one or more portions of the environment 200 can be implemented as an algorithm on the hardware components of one or more devices or systems (e.g., the vehicle 104, the vehicle computing system 108, and/or the operations computing system 150, shown in FIG. 1) to, for example, determine the physical dimensions and orientation of objects. As illustrated, FIG. 2 shows an environment 200 that includes an object 210, a bounding shape 212, an object orientation 214, a road 220, and a lane marker 222.

In the environment 200 (e.g., a highway), a vehicle computing system (e.g., the vehicle computing system 108) can receive outputs from one or more sensors (e.g., sensor output from one or more cameras, sonar devices, RADAR devices, thermal imaging devices, and/or LIDAR devices) to detect objects including the object 210 and the lane marker 222 which is a painted line on the road 220, and which can be used to determine traffic flow patterns for objects on the road 220. In some embodiments, the vehicle computing system can receive map data that includes one or more indications of the location of objects including lane markers, curbs, sidewalks, streets, and/or roads. The vehicle computing system can determine based in part on the sensor output, through use of a machine learned model, and data associated with the environment 200 (e.g., map data indicating the presence of roads and the direction of travel on the roads) that the object 210 is a vehicle (e.g., an automobile) in transit. The vehicle computing system can determine the shape of the object 210 based in part on the sensor output and the use of a machine learned model that uses previously classified objects to determine that the detected object 210 is a vehicle (e.g., the physical dimensions, color, velocity, and other characteristics of the object correspond to a vehicle class). Based on the detected physical dimensions of the object 210, the vehicle computing system can generate the bounding shape 212, which can define the outer edges of the object 210. Further, based on the sensor outputs and/or using the machine learned model, the vehicle computing system can determine an object orientation 214 for the object 210. The object orientation 214 can be used to determine a travel path, trajectory, and/or direction of travel for the object 210.

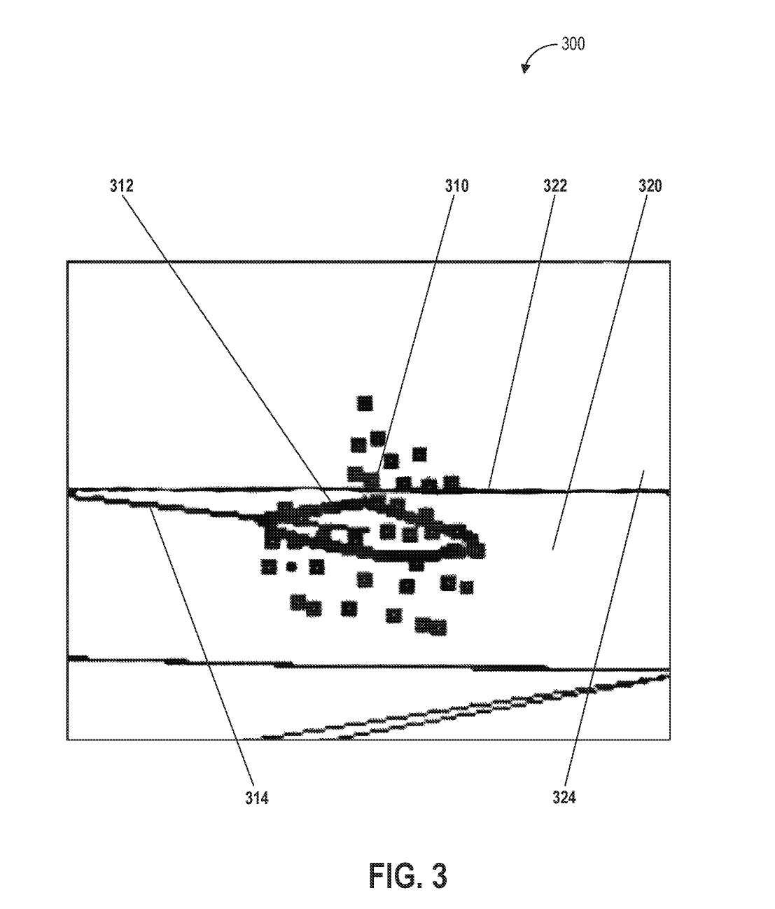

FIG. 3 depicts an example of detecting an object and determining the object's orientation according to example embodiments of the present disclosure. One or more portions of the environment 300 can be detected and processed by one or more devices (e.g., one or more computing devices) or systems including, for example, the vehicle 104, the vehicle computing system 108, and/or the operations computing system 150, shown in FIG. 1. Moreover, the detection and processing of one or more portions of the environment 300 can be implemented as an algorithm on the hardware components of one or more devices or systems (e.g., the vehicle 104, the vehicle computing system 108, and/or the operations computing system 150, shown in FIG. 1) to, for example, determine the physical dimensions and orientation of objects. As illustrated, FIG. 3 shows an environment 300 that includes an object 310, a bounding shape 312, an object orientation 314, a road 320, a curb 322, and a sidewalk 324.

In the environment 300 (e.g., an urban area including a road and sidewalk), a vehicle computing system (e.g., the vehicle computing system 108) can receive outputs from one or more sensors (e.g., sensor output from one or more cameras, sonar devices, thermal imaging devices, RADAR devices, and/or LIDAR devices) to detect objects including the object 310 (e.g., a bicycle ridden by a person) and the curb 322 which is part of a sidewalk 324 that is elevated from the road 320, and separates areas primarily for use by vehicles (e.g., the road 320) from areas primarily for use by pedestrians (e.g., the sidewalk 324). Further, the vehicle computing system can determine one or more characteristics of the environment 300 including the physical dimensions, color, velocity, and/or shape of objects in the environment 300. The vehicle computing system can determine based on the sensor output and through use of a machine learned model that the object 310 is a cyclist in transit. The determination that the object 310 is a cyclist can be based in part on a comparison of the detected characteristics of the object 310 to previously classified features that correspond to the features detected by the sensors including the size, coloring, and velocity of the object 310. Further, the vehicle computing system can determine the shape of the object 310 based in part on the sensor output and the use of a machine learned model that uses previously classified objects to determine that the detected object 310 is a cyclist (e.g., the physical dimensions and other characteristics of the object 310 correspond to one or more features of a cyclist class). Based in part on the detected physical dimensions of the object 310, the vehicle computing system can generate the bounding shape 312, which can define the outer edges of the object 310. Further, based in part on the sensor outputs and/or using the machine learned model, the vehicle computing system can determine an object orientation 314, which can indicate a path, trajectory, and/or direction of travel for the object 310.

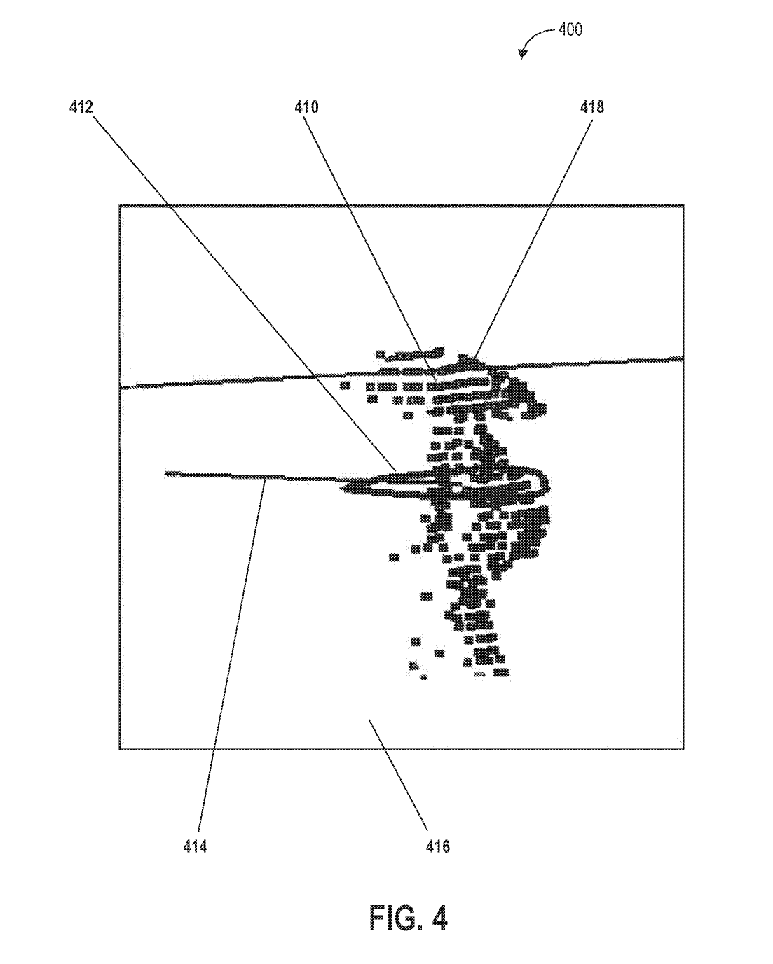

FIG. 4 depicts an example of detecting an object and determining the object's orientation according to example embodiments of the present disclosure. One or more portions of the environment 400 can be detected and processed by one or more devices (e.g., one or more computing devices) or systems including, for example, the vehicle 104, the vehicle computing system 108, and/or the operations computing system 150, shown in FIG. 1. Moreover, the detection and processing of one or more portions of the environment 400 can be implemented as an algorithm on the hardware components of one or more devices or systems (e.g., the vehicle 104, the vehicle computing system 108, and/or the operations computing system 150, shown in FIG. 1) to, for example, determine the physical dimensions and orientation of objects. As illustrated, FIG. 4 shows an environment 400 that includes an object 410 (e.g., a pedestrian), a bounding shape 412, an object orientation 414, a sidewalk 416, and an object 418.

In the environment 400 (e.g., a suburban area with a sidewalk), a vehicle computing system (e.g., the vehicle computing system 108) can receive outputs from one or more sensors (e.g., sensor output from one or more cameras, sonar devices, thermal imaging devices, RADAR devices, and/or LIDAR devices) to detect objects including the object 410 (e.g., a pedestrian) and the sidewalk 416 that the object 410 is travelling on. The vehicle computing system can determine based in part on the sensor output and through use of a machine learned model that the object 410 is a pedestrian in transit. Further, the determination that the object 410 is a pedestrian can be based in part on a comparison of the determined characteristics of the object 410 to previously classified features that correspond to the features detected by the sensors including the size, coloring, and movement patterns (e.g., the gait of the pedestrian) of the object 410. The vehicle computing system can determine the shape of the object 410 based in part on the sensor output and the use of a machine learned model that uses previously classified objects to determine that the detected object 410 is a pedestrian (e.g., the physical dimensions and other characteristics of the object 410 correspond to a pedestrian class). Further, through use of the sensor output and the machine learned model, the vehicle computing system can determine that the object 418 (e.g., an umbrella) is an implement that is being carried by the object 410. Based in part on the detected physical dimensions of the object 410, the vehicle computing system can generate the bounding shape 412, which can define the outer edges of the object 410. Further, based on the sensor outputs and/or using the machine learned model, the vehicle computing system can determine an object orientation 414, which can indicate a path, trajectory, and/or direction of travel for the object 410.

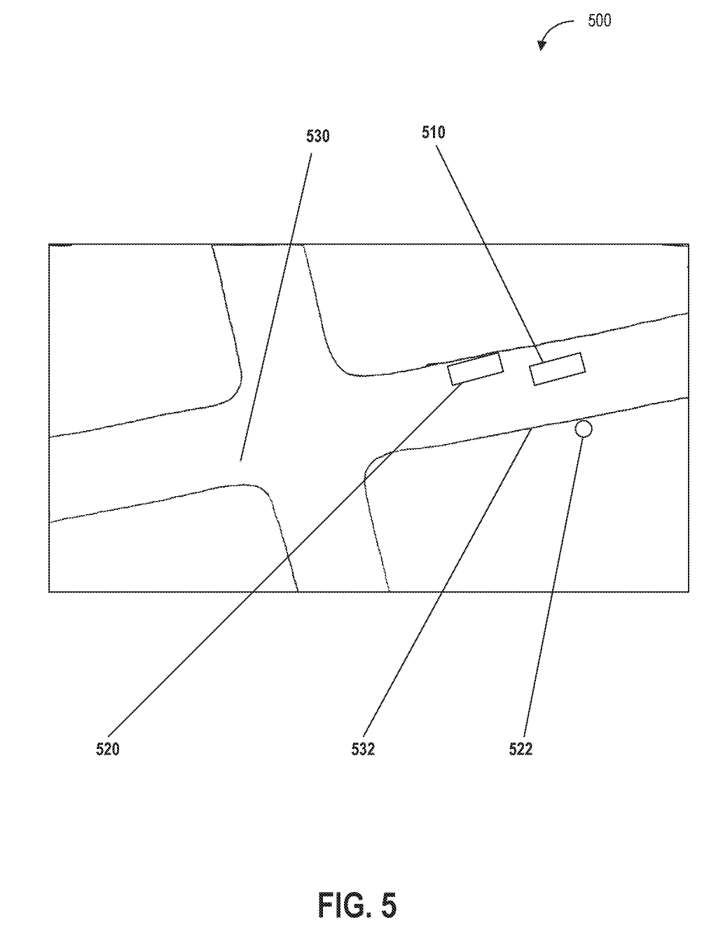

FIG. 5 depicts an example of an environment including a plurality of detected objects according to example embodiments of the present disclosure. One or more portions of the environment 500 can be detected and processed by one or more devices (e.g., one or more computing devices) or systems including, for example, the vehicle 104, the vehicle computing system 108, and/or the operations computing system 150, shown in FIG. 1. Moreover, the detection and processing of one or more portions of the environment 500 can be implemented as an algorithm on the hardware components of one or more devices or systems (e.g., the vehicle 104, the vehicle computing system 108, and/or the operations computing system 150, shown in FIG. 1) to, for example, determine the physical dimensions and orientation of objects. As illustrated, FIG. 5 shows an environment 500 that includes an autonomous vehicle 510, an object 520, an object 522, a road 530, and a curb 532.

In the environment 500, the autonomous vehicle 510 can detect objects within range of sensors (e.g., one or more cameras, sonar devices, thermal imaging devices, RADAR devices, and/or LIDAR devices) associated with the autonomous vehicle 510. The detected objects can include the object 520, the object 522, the road 530, and the curb 532. Further, the autonomous vehicle 510 can identify the detected objects (e.g., identification of the objects based on sensor outputs and use of a machine learned model) and determine the locations, orientations, and/or travel paths of the detected objects. The autonomous vehicle 510 is able to determine the state of the objects through a combination of sensor outputs, a machine learned model, and data associated with the state of the environment 500 (e.g., map data that indicates the location of roads, sidewalks, buildings, traffic signals, and/or landmarks). For example, the autonomous vehicle 510 can determine that the object 520 is a parked automobile based in part on the detected shape, size, and velocity (e.g., 0 m/s) of the object 520. The autonomous vehicle 510 can also determine that the object 522 is a pedestrian based in part on the shape, size, and velocity of the object 522 as well as the contextual data based on the object 522 being on a portion of the environment 500 that is reserved for pedestrians and which is separated from the road 530 by the curb 532.

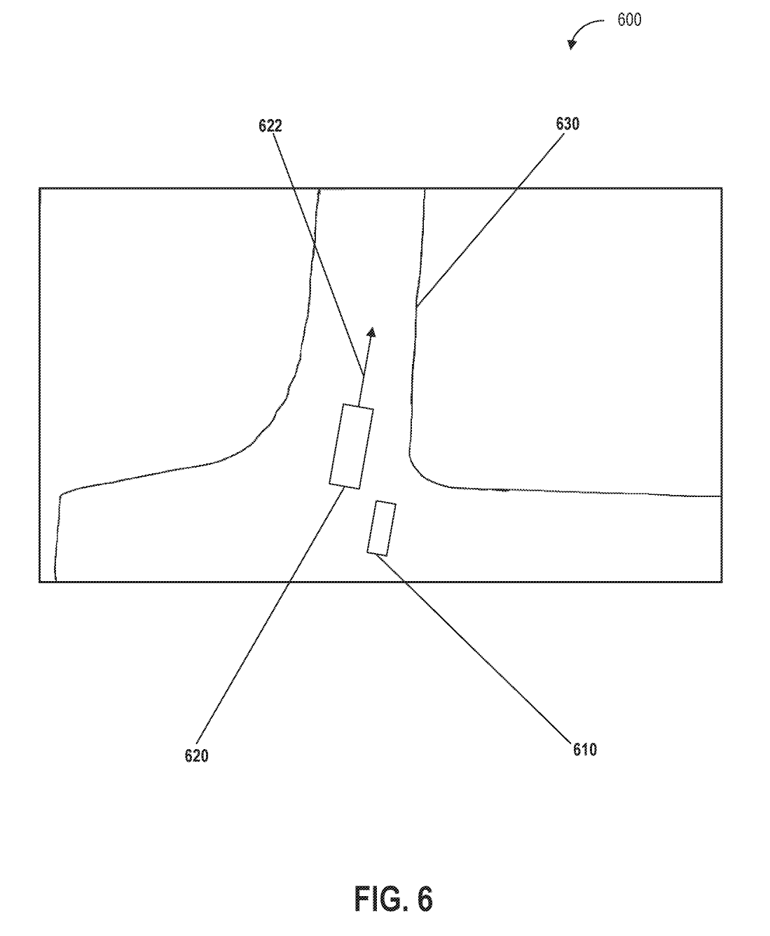

FIG. 6 depicts an example of an environment including a plurality of detected objects according to example embodiments of the present disclosure. One or more portions of the environment 600 can be detected and processed by one or more devices (e.g., one or more computing devices) or systems including, for example, the vehicle 104, the vehicle computing system 108, and/or the operations computing system 150, shown in FIG. 1. Moreover, the detection and processing of one or more portions of the environment 600 can be implemented as an algorithm on the hardware components of one or more devices or systems (e.g., the vehicle 104, the vehicle computing system 108, and/or the operations computing system 150, shown in FIG. 1) to, for example, determine the physical dimensions and orientation of objects. As illustrated, FIG. 6 shows an environment 600 that includes an autonomous vehicle 610, an object 620, an object orientation 622, and a curb 630.

In the environment 600, the autonomous vehicle 610 can detect objects within range of one or more sensors (e.g., one or more cameras, sonar devices, thermal imaging devices, RADAR devices, and/or LIDAR devices) associated with the autonomous vehicle 610. The detected objects can include the object 620 and the curb 630. Further, the autonomous vehicle 610 can identify the detected objects (e.g., identification of the objects based on sensor outputs and use of a machine learned model) and determine the locations, orientations, and travel paths of the detected objects including the orientation 622 for the object 620. The autonomous vehicle 610 is able to determine the state of the objects through a combination of sensor outputs, a machine learned model, and data associated with the state of the environment 600 (e.g., map data that indicates the location of roads, sidewalks, buildings, traffic signals, and/or landmarks). Further, as shown, the autonomous vehicle 610 is able to determine the orientation 622 for the object 620 based in part on the sensor output, a travel path estimate based on the determined velocity and direction of travel of the object 620, and a comparison of one or more characteristics of the object 620 (e.g., the physical dimensions and color) to the one or more classified features of a machine learned model.

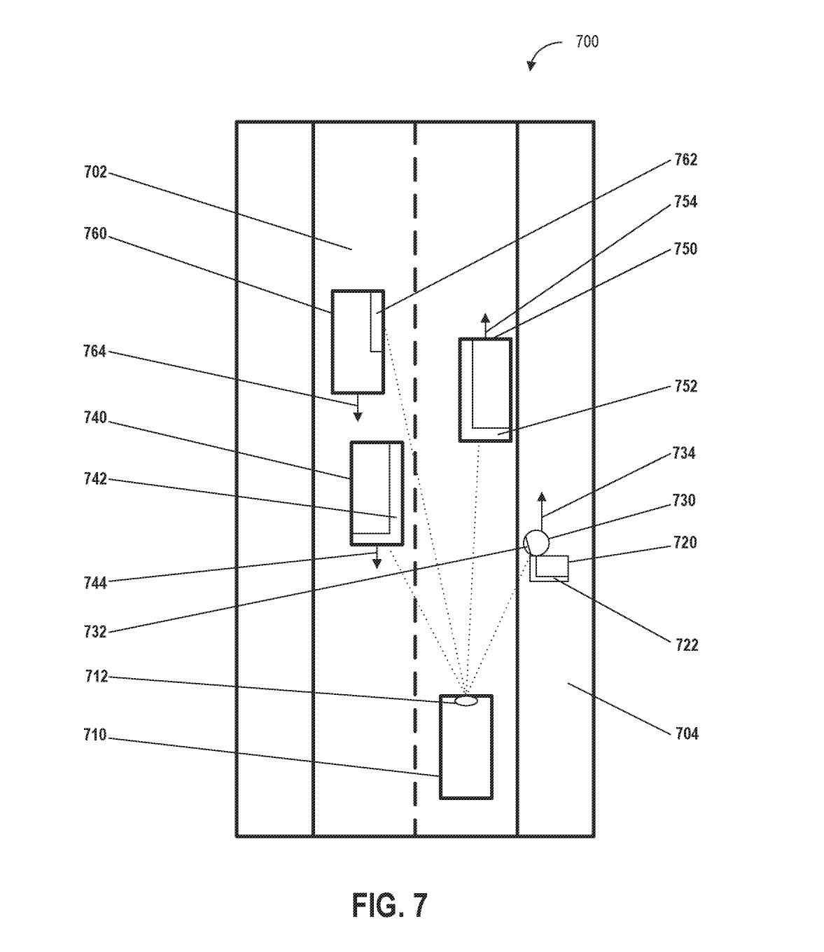

FIG. 7 depicts a third example of an environment including a plurality of partially occluded objects according to example embodiments of the present disclosure. One or more portions of the environment 700 can be detected and processed by one or more devices (e.g., one or more computing devices) or systems including, for example, the vehicle 104, the vehicle computing system 108, and/or the operations computing system 150, shown in FIG. 1. Moreover, the detection and processing of one or more portions of the environment 700 can be implemented as an algorithm on the hardware components of one or more devices or systems (e.g., the vehicle 104, the vehicle computing system 108, and/or the operations computing system 150, shown in FIG. 1) to, for example, determine the physical dimensions and orientation of objects. As illustrated, FIG. 7 shows an environment 700 that includes a road area 702, a sidewalk area 704, an autonomous vehicle 710, a sensor suite 712, an object 720, a detected object portion 722, an object 730, a detected object portion 732, an object path 734; an object 740, a detected object portion 742, an object path 744, an object 750, a detected object portion 752, an object path 754, an object 760, a detected object portion 762, and an object path 764.

In the environment 700 the autonomous vehicle 710 can include a sensor suite 712 that includes one or more sensors (e.g., optical sensors, acoustic sensors, and/or LIDAR) that can be used to determine the state of the environment 700, including the road 702, the sidewalk 704, and any objects (e.g., the object 720) within the environment 700. Based on the determined state of the environment 700, the autonomous vehicle 710 can determine one or more characteristics (e.g., size, shape, color, velocity, acceleration, and/or movement patterns) of the one or more objects (e.g., the objects 720/730/740/750/760) that can be used to determine the physical dimensions, orientations, and paths of the one or more objects

In this example, the autonomous vehicle 710 detects, relative to the position of the autonomous vehicle: the object portion 722 which is the front side and left side of the object 720; the object portion 732 which is the left side of the object 730 which is partially blocked by the object 720; the object portion 742 which is the front side and right side of the object 740; the object portion 752 which is the rear side and left side of the object 750; and the object portion 762 which is a portion of the right side of the object 760, which is partially blocked by the object 740. Based in part on the sensor output, use of a machine learned model, and data associated with the state of the environment 700 (e.g., map data including imagery of one or more portions of the environment 700), the autonomous vehicle 710 can identify one or more objects including the objects 720/730/740/750/760.

Further, the autonomous vehicle 710 can generate an estimated set of physical dimensions for each of the objects detected by one or more sensors of the autonomous vehicle 710. For example, the autonomous vehicle 710 can determine physical dimensions for: the object 720 based on the object portion 722; the object 730 based on the object portion 732; the object 740 based on the object portion 742; the object 750 based on the object portion 752; and the object 760 and the object portion 762. Based on the determined characteristics of the object 720/730/740/750/760, including the physical dimensions, the autonomous vehicle 710 can determine that the object 720 is a mailbox based in part on the color and physical dimensions of the object 720; the object 730 is a pedestrian based in part on the motion characteristics and physical dimensions of the object 730; the objects 740/750/760 are automobiles based in part on the velocity and physical dimensions of the objects 740/750/760.

Further the autonomous vehicle 710 can determine, based on the one or more characteristics of the objects 720/730/740/750/760 including orientations and paths for each of the objects 720/730/740/750/760. For example, the autonomous vehicle 710 can determine that the object 720 is static and does not have an object path; the object 730 has an object path 734 moving parallel to and in the same direction as the autonomous vehicle 710; the object 740 has an object path 744 moving toward the autonomous vehicle 710; the object 750 has an object path 754 and is moving away from the autonomous vehicle 710; and the object 760 has an object path 764 and is moving toward the autonomous vehicle 710.

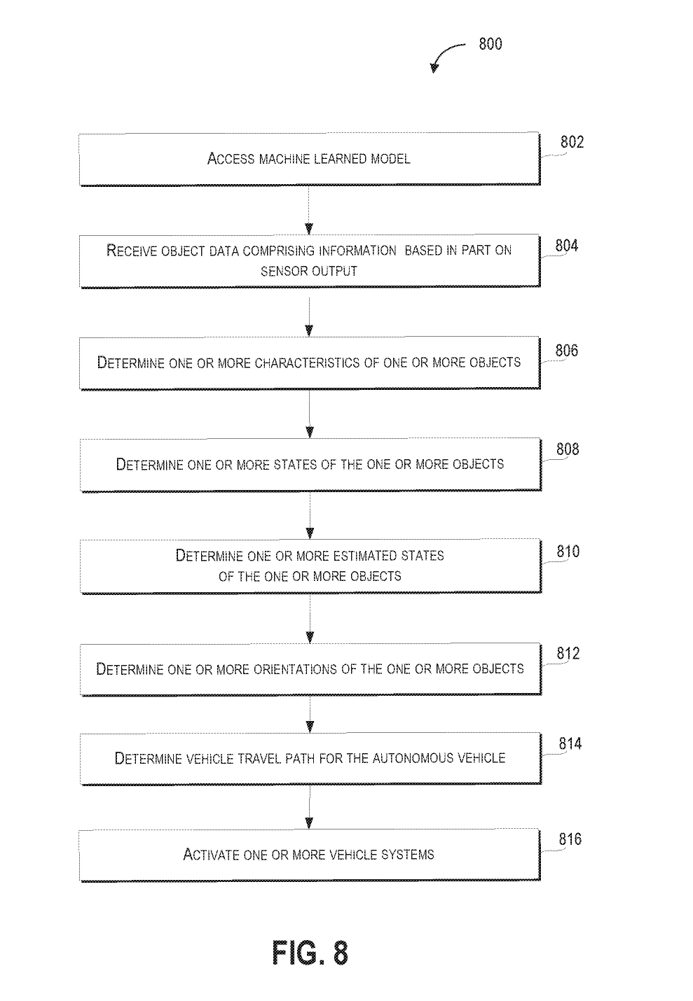

FIG. 8 depicts a flow diagram of an example method of determining object orientation according to example embodiments of the present disclosure. One or more portions of the method 800 can be implemented by one or more devices (e.g., one or more computing devices) or systems including, for example, the vehicle 104, the vehicle computing system 108, and/or the operations computing system 150, shown in FIG. 1. Moreover, one or more portions of the method 800 can be implemented as an algorithm on the hardware components of one or more devices or systems (e.g., the vehicle 104, the vehicle computing system 108, and/or the operations computing system 150, shown in FIG. 1) to, for example, detect, track, and determine physical dimensions and/or orientations of one or more objects within a predetermined distance of an autonomous vehicle. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At 802, the method 800 can include accessing a machine learned model. The machine learned model can include a machine learned model that has been generated and/or trained in part using classifier data that includes a plurality of classified features and a plurality of classified object labels associated with training data that can be based on, or associated with, a plurality of training objects (e.g., a set of physical or simulated objects that are used as inputs to train the machine learned model). In some embodiments, the plurality of classified features can be extracted from point cloud data that includes a plurality of three-dimensional points associated with sensor output including optical sensor output from one or more optical sensor devices (e.g., cameras and/or LIDAR devices).

The vehicle computing system can access the machine learned model (e.g., the machine learned model at 802) in a variety of ways including exchanging (sending or receiving via a network) data or information associated with a machine learned model that is stored on a remote computing device (e.g., a set of server computing devices at a remote location); or accessing a machine learned model that is stored locally (e.g., in a storage device onboard the vehicle or part of the vehicle computing system).

The plurality of classified features (e.g., the plurality of classified features used to generate and/or train the machine learned model accessed at 802) can be associated with one or more values that can be analyzed individually or in aggregate. Processing and/or analysis of the one or more values associated with the plurality of classified features can include determining various properties of the one or more features including statistical and/or probabilistic properties. Further, analysis of the one or more values associated with the plurality of features can include determining a cardinality, mean, mode, median, variance, covariance, standard deviation, maximum, minimum, and/or frequency of the one or more values associated with the plurality of classified features. Further, the analysis of the one or more values associated with the plurality of classified features can include comparisons of the differences or similarities between the one or more values. For example, vehicles can be associated with set of physical dimension values (e.g., shape and size) and color values that are different from the physical dimension values and color values associated with a pedestrian.

In some embodiments, the plurality of classified features (e.g., the plurality of classified features used to generate and/or train the machine learned model accessed at 802) can include a range of velocities associated with the plurality of training objects, a one or more color spaces (e.g., a color space based on a color model including luminance and/or chrominance) associated with the plurality of training objects, a range of accelerations associated with the plurality of training objects, a length of the plurality of training objects, a width of the plurality of training objects, and/or a height of the plurality of training objects.

The plurality of classified features (e.g., the plurality of classified features used to generate and/or train the machine learned model accessed at 802) can be based in part on the output from one or more sensors that have captured a plurality of training objects (e.g., actual objects used to train the machine learned model) from various angles and/or distances in different environments (e.g., urban areas, suburban areas, rural areas, heavy traffic, and/or light traffic) and/or environmental conditions (e.g., bright daylight, overcast daylight, darkness, wet reflective roads, in parking structures, in tunnels, and/or under streetlights). The one or more classified object labels, which can be used to classify or categorize the one or more objects, can include buildings, roadways, bridges, bodies of water (e.g., waterways), geographic features (e.g., hills, mountains, desert, plains), pedestrians, vehicles (e.g., automobiles, trucks and/or tractors), cyclists, signage (e.g., traffic signs and/or commercial signage) implements (e.g., umbrellas, shovels, wheel barrows), and/or utility structures (e.g., telephone poles, overhead power lines, cell phone towers).

In some embodiments, the classifier data can be based in part on a plurality of classified features extracted from sensor data associated with output from one or more sensors associated with a plurality of training objects (e.g., previously classified buildings, roadways, pedestrians, vehicles, and/or cyclists). The sensors used to obtain sensor data from which features can be extracted can include one or more light detection and ranging devices (LIDAR), one or more infrared sensors, one or more thermal sensors, one or more radar devices, one or more sonar devices, and/or one or more cameras.

The machine learned model (e.g., the machine learned model accessed at 802) can be generated based in part on one or more classification processes or classification techniques. The one or more classification processes or classification techniques can include one or more computing processes performed by one or more computing devices based in part on object data associated with physical outputs from a sensor device (e.g., signals or data transmitted from a sensor that has detected a sensor input). The one or more computing processes can include the classification (e.g., allocation, ranking, or sorting into different groups or categories) of the physical outputs from the sensor device, based in part on one or more classification criteria (e.g., a color, size, shape, velocity, or acceleration associated with an object).

At 804, the method 800 can include receiving object data that is based in part on one or more states, properties, or conditions of one or more objects. The one or more objects can include any object external to the vehicle including buildings (e.g., houses and/or high-rise buildings); foliage and/or trees; one or more pedestrians (e.g., one or more persons standing, laying down, sitting, walking, or running); utility structures (e.g., electricity poles, over-head power lines, and/or fire hydrants); one or more other vehicles (e.g., automobiles, trucks, buses, motorcycles, mopeds, aircraft, boats, amphibious vehicles, and/or trains); one or more containers in contact with, connected to, or attached to the one or more objects (e.g., trailers, carriages, and/or implements); and/or one or more cyclists (e.g., persons sitting or riding on bicycles). Further, the object data can be based in part on one or more states of the one or more objects including physical properties or characteristics of the one or more objects. The one or more states, properties, or conditions associated with the one or more objects can include the color, shape, texture, velocity, acceleration, and/or physical dimensions (e.g., length, width, and/or height) of the one or more objects or portions of the one or more objects (e.g., a side of the one or more objects that is facing the vehicle).

In some embodiments, the object data (e.g., the object data received at 804) can include a set of three-dimensional points (e.g., x, y, and z coordinates) associated with one or more physical dimensions (e.g., the length, width, and/or height) of the one or more objects, one or more locations (e.g., geographical locations) of the one or more objects, and/or one or more relative locations of the one or more objects relative to a point of reference (e.g., the location of a portion of the autonomous vehicle). In some embodiments, the object data can be based on outputs from a variety of devices or systems including vehicle systems (e.g., sensor systems of the vehicle); systems external to the vehicle including remote sensor systems (e.g., sensor systems on traffic lights or roads, or sensor systems on other vehicles); and/or remote data sources (e.g., remote computing devices that provide sensor data).

The object data can include one or more sensor outputs from one or more sensors of the autonomous vehicle. The one or more sensors can be configured to detect a plurality of three-dimensional positions or locations of surfaces (e.g., the x, y, and z coordinates of the surface of a cyclist based in part on a reflected laser pulse from a LIDAR device of the cyclist) of the one or more objects. The one or more sensors can detect the state (e.g., physical characteristics or properties, including dimensions) of the environment or one or more objects external to the vehicle and can include one or more thermal imaging devices, one or more light detection and ranging (LIDAR) devices, one or more radar devices, one or more sonar devices, and/or one or more cameras.

In some embodiments, the object data can be based in part on the output from one or more vehicle systems (e.g., systems that are part of the vehicle) including the sensor output (e.g., one or more three-dimensional points associated with the plurality of three-dimensional positions of the surfaces of one or more objects) from the one or more sensors. The object data can include information that is based in part on sensor output associated with one or more portions of the one or more objects that are detected by one or more sensors of the autonomous vehicle.

At 806, the method 800 can include determining, based in part on the object data (e.g., the object data received at 804) and a machine learned model (e.g., the machine learned model accessed at 802), one or more characteristics of the one or more objects. The one or more characteristics of the one or more objects can include the properties or qualities of the object data including the temperature, shape, texture, velocity, acceleration, and/or physical dimensions (e.g., length, width, and/or height) of the one or more objects and/or portions of the one or more objects (e.g., a portion of an object that is not blocked by another object); and/or one or more movement characteristics of the one or more objects (e.g., movement patterns of the one or more objects). Further, the one or more characteristics of the one or more objects can include an estimated set of physical dimensions of one or more objects (e.g., an estimated set of physical dimensions based in part on the one or more portions of the one or more objects that are detected by the one or more sensors of the vehicle). For example, the vehicle computing system can use the one or more sensors to detect a rear portion of a trailer and estimate the physical dimensions of the trailer based on the physical dimensions of the detected rear portion of the trailer. Based on a determination that the trailer is in motion, the vehicle computing system can determine that the trailer is being towed by a vehicle (e.g., a truck) and generate an estimated set of physical dimensions of the vehicle based on the estimated physical dimensions of the trailer. Further, the one or more characteristics can include properties or qualities of the object data that can be determined or inferred from the object data including volume (e.g., using the size of a portion of an object to determine a volume of the entire object) or shape (e.g., mirroring one side of an object that is not detected by the one or more sensors to match the side that is detected by the one or more sensors).

The vehicle computing system can determine the one or more characteristics of the one or more objects by applying the object data to the machine learned model. For example, the one or more sensor devices can include LIDAR devices that can determine the shape of an object based in part on object data that is based on the physical inputs to the LIDAR devices (e.g., the laser pulses reflected from the object) when one or more objects are detected by the LIDAR devices. The machine learned model can be used to compare the detected shape to classified shapes that are part of the model.

In some embodiments, the machine learned model can compare the object data to the classifier data based in part on sensor outputs captured from the detection of one or more classified objects (e.g., thousands or millions of objects) in a variety of environments or conditions. Based on the comparison, the vehicle computing system can determine one or more characteristics of the one or more objects. The one or more characteristics can be mapped to, or associated with, one or more classes based in part on one or more classification criteria. For example, one or more classification criteria can distinguish a member of a cyclist class from a member of a pedestrian class based in part on their respective sets of features. The member of a cyclist class can be associated with one set of movement features (e.g., rotary motion by a set of wheels) and a member of a pedestrian class can be associated with a different set of movement features (e.g., reciprocating motion by a set of legs).

At 808, the method 800 can include determining, based in part on the object data (e.g., the object data received at 804) and/or the one or more characteristics of the one or more objects, one or more states of the one or more objects. The one or more estimated states of the one or more objects over the set of the plurality of time periods can include one or more locations of the one or more objects over the set of the plurality of time periods, the estimated set of physical dimensions of the one or more objects over the set of the plurality of time periods, or one or more classified object labels associated with the one or more objects over the set of the plurality of time periods or time interval (e.g., a time interval between two chronological times of day or a time period of a predetermined duration). The one or more locations of the one or more objects can include geographic locations or positions (e.g., the latitude and longitude of the one or more objects) and/or the location of the one or more objects relative to a point of reference (e.g., a portion of the vehicle). For example, the vehicle computing system can include one or more sensors (e.g., cameras, sonar, thermal imaging devices, RADAR devices and/or LIDAR devices positioned on the vehicle) that capture the movement of objects over time and provide the sensor output to processors of the vehicle computing system to distinguish and/or identify objects, and determine the location of each of the objects.

At 810, the method 800 can include determining one or more estimated states of the one or more objects based in part on changes in the one or more states of the one or more objects over the predetermined time interval or time period. The one or more estimated states of the one or more objects can include one or more locations of the one or more objects.

In some embodiments, the one or more states of the one or more objects can include one or more travel paths of the one or more objects, including a travel path for an object that includes the portion of the travel path that the object has traversed over the predetermined time interval or time period (e.g., a travel path that is based on previous sensor outputs of the one or more locations of the one or more objects) or time period and a portion of the travel path that the object is determined to traverse at subsequent time intervals or time periods, based on characteristics (e.g., the shape) of the portion of the travel path that the object has traversed. The shape of the travel path of an object at a specified time interval or time period can correspond to the orientation of the object during that specified time interval or time period (e.g., an object travelling in a straight line can have an orientation that is the same as its travel path). As such, in some embodiments, the one or more orientations of the one or more objects can be based in part on the one or more travel paths.

At 812, the method 800 can include determining, based in part on the one or more characteristics of the one or more objects, one or more orientations of the one or more objects. Further, the one or more orientations of the one or more objects can be based in part on one or more characteristics that were determined (e.g., the one or more characteristics determined at 806) and can include one or more characteristics that are estimated or predicted by the vehicle computing system of the one or more objects including the estimated set of physical dimensions. The one or more characteristics of the one or more objects can be used to determine one or more orientations of the one or more objects based on the velocity, trajectory, path, and/or direction of travel of the one or more objects, and/or a shape of a portion of the one or more objects (e.g., the shape of a rear door of a truck).

The one or more orientations of the one or more objects can be relative to a point of reference including a compass orientation (e.g., an orientation relative to the geographic or magnetic north pole or south pole); relative to a fixed point of reference (e.g., a geographic landmark with a location and orientation that is determined by the vehicle computing system), and/or relative to the location of the autonomous vehicle.

At 814, the method 800 can include determining a vehicle travel path for the autonomous vehicle. In some embodiments, the vehicle travel path (e.g., a vehicle travel path of the one or more travel paths) can be based in part on the one or more travel paths of the one or more objects (e.g., the one or more travel paths of the one or more objects determined at 810), and can include a vehicle travel path for the autonomous vehicle in which the autonomous vehicle does not intersect the one or more objects. The vehicle travel path can include a path or course that the vehicle can traverse so that the vehicle will not come into contact with any of the one or more objects or come within a predetermined distance range of any surface of the one or more objects (e.g., the vehicle will not come closer than one meter away from any surface of the one or more objects). In some embodiments, the activation of the one or more vehicle systems associated with the autonomous vehicle can be based in part on the vehicle travel path.

At 816, the method 800 can include activating one or more vehicle systems of the vehicle. The activation of the one or more vehicle systems can be based in part on the one or more orientations of the one or more objects, the one or more travel paths of the one or more objects, and/or the travel path of the vehicle. For example, the vehicle computing system can activate one or more vehicle systems including one or more communication systems that can exchange (send or receive) signals or data with other vehicle systems, other vehicles, or remote computing devices; one or more safety systems (e.g., one or more airbags or other passenger protection devices); one or more notification systems that can generate caution indications (e.g., visual or auditory messages) when one or more travel paths of the one or more objects are determined to intersect the vehicle within a predetermined time period (e.g., the vehicle computing system generates a caution indication when it is determined that the vehicle will intersect one or more objects within five seconds); braking systems that can be used to slow the vehicle when the travel paths of the one or more objects are determined to intersect a travel path of the vehicle within a predetermined time period; propulsion systems (e.g., engines or motors that are used to move the vehicle) that can change the acceleration or velocity of the vehicle; and/or steering systems that can change the path, course, and/or direction of travel of the vehicle.

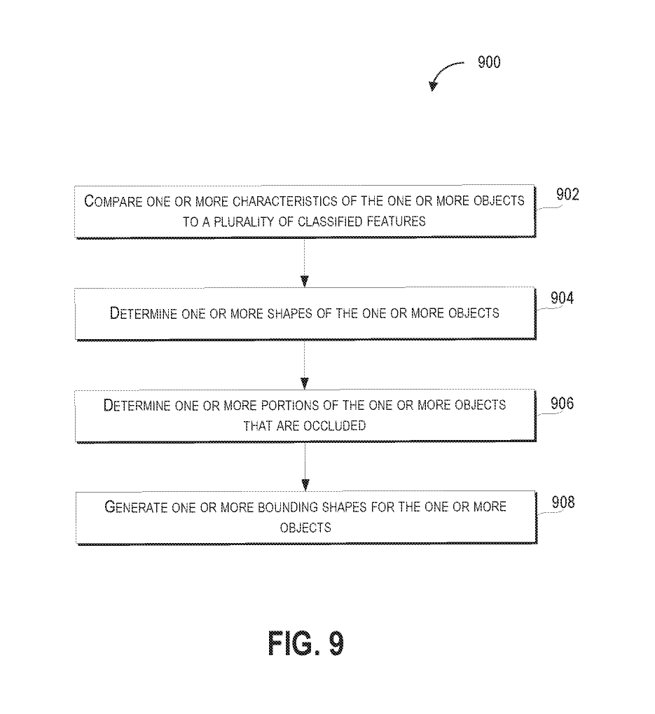

FIG. 9 depicts a flow diagram of an example method of determining object bounding shapes according to example embodiments of the present disclosure. One or more portions of the method 900 can be implemented by one or more devices (e.g., one or more computing devices) or systems including, for example, the vehicle 104, the vehicle computing system 108, and/or the operations computing system 150, shown in FIG. 1. Moreover, one or more portions of the method 900 can be implemented as an algorithm on the hardware components of one or more devices or systems (e.g., the vehicle 104, the vehicle computing system 108, and/or the operations computing system 150, shown in FIG. 1) to, for example, detect, track, and determine physical dimensions and/or orientations of one or more objects within a predetermined distance of an autonomous vehicle which can be performed using classification techniques including the use of a machine learned model. FIG. 9 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure.

At 902, the method 900 can include comparing one or more characteristics of the one or more objects to a plurality of classified features associated with the plurality of training objects. The one or more characteristics of the one or more objects can include the properties, conditions, or qualities of the one or more objects based in part on the object data including the temperature, shape, texture, velocity, acceleration, and/or physical dimensions (e.g., length, width, and/or height) of the one or more objects and/or portions of the one or more objects (e.g., a portion of an object that is blocked by another object); one or more movement characteristics of the one or more objects (e.g., movement patterns of the one or more objects); and/or the estimated set of physical dimensions (e.g., height, length, width) of the one or more objects. The comparison of the one or more characteristics of the one or more objects to the plurality of classified features associated with the plurality of training objects can include the determination of values for each of the one or more characteristics and comparing the values to one or more values associated with the plurality of classified features associated with the plurality of training objects. Based in part on the comparison the vehicle computing system can determine differences and similarities between the one or more characteristics of the one or more objects and the plurality of classified features associated with the plurality of training objects.

At 904, the method 900 can include determining one or more shapes of the one or more objects (e.g., one or more shapes corresponding to the one or more objects). For example, the vehicle computing system can determine that an object is a cyclist based on a comparison of the one or more characteristics of the object (e.g., the size and movement patterns of the cyclist) to the plurality of training objects which includes classified cyclists of various sizes (various sized people riding various sized bicycles), shapes (e.g., different types of bicycles including unicycles and tandem bicycles), and velocities. The one or more shapes corresponding to the one or more objects can be used to determine sides of the one or more objects including a front side, a rear side (e.g., back side), a left side, a right side, a top side, or a bottom side, of the one or more objects. The spatial relationship between the sides of the one or more objects can be used to determine the one or more orientations of the one or more objects. For example, the narrower side of a cyclist (e.g., the profile of a cyclist from the front side or the rear side) in combination with the determined movement patterns of the cyclist (e.g., the reciprocating motion of the cyclist's legs) can be an indication of the axis along which the cyclist is oriented. In some embodiments, the one or more orientations of the one or more objects can be based in part on the one or more shapes of the one or more objects.

At 906, the method 900 can include determining, based in part on the object data or the machine learned model (e.g., the machine learned model accessed at 802 in FIG. 8), one or more portions of the one or more objects that are occluded (e.g., partly or wholly blocked or obstructed from detection by the one or more sensors of the autonomous vehicle). For example, one or more portions of the one or more objects can be occluded from the one or more sensors of the vehicle by various things including other objects (e.g., an automobile that blocks a portion of another automobile); and/or environmental conditions (e.g., snow, fog, and or rain that blocks a portion of a sensor or a portion of a detected object).

In some embodiments, the estimated set of physical dimensions (e.g., the estimated set of physical dimensions for the one or more objects in 902) for the one or more objects can be based in part on the one or more portions of the one or more objects that are not occluded (e.g., not occluded from detection by the one or more sensors) by at least one other object of the one or more objects. Based in part on a classification of a portion of an object that is detected by the one or more sensors as corresponding to a previously classified object, the physical dimensions of the previously classified object can be mapped onto the portion of the object that is partly visible to the one or more sensors and used as the estimated set of physical dimensions. For example, the one or more sensors can detect a front portion of an automobile that is occluded by a pedestrian and a truck that is parked in front of the automobile. Based in part on the portion of the vehicle that is detected (i.e., the front portion), the vehicle computing system can determine the physical dimensions of the portions of the vehicle that were not detected. In some embodiments, the one or more bounding shapes can be based in part on the estimated set of physical dimensions of the one or more objects (e.g., the bounding shapes can follow the contours of the estimated set of physical dimensions of the one or more objects).

At 908, the method 900 can include generating, based in part on the object data, one or more bounding shapes (e.g., two-dimensional or three dimensional bounding ellipsoids, bounding polygons, or bounding boxes) that surround one or more areas, volumes, sections, or regions associated with the one or more physical dimensions and/or the estimated set of physical dimensions of the one or more objects. The one or more bounding shapes can include one or more polygons that surround a portion or the entirety of the one or more objects. For example, the one or more bounding shapes can surround or envelope the one or more objects that are detected by one or more sensors (e.g., LIDAR devices) onboard the vehicle.

In some embodiments, the one or more orientations of the one or more objects (e.g., the one or more orientations of the one or more objects determined at 812 in FIG. 8) can be based in part on characteristics of the one or more bounding shapes (e.g., the one or more bounding shapes generated at 908) including a length, a width, a height, or a center-point associated with the one or more bounding shapes. For example, the vehicle computing system can determine the one or more orientations of the object based on the distance between the center point of the bounding shape and the outside edges (e.g., along the perimeter) of the bounding shape. Based in part on the determination of the longest distance between the center point of the bounding shape and the outside edges of the bounding shape, the vehicle computing system can determine the orientation for the object based on the position or orientation of a line between the center point of the bounding shape and the edge of the bounding shape.

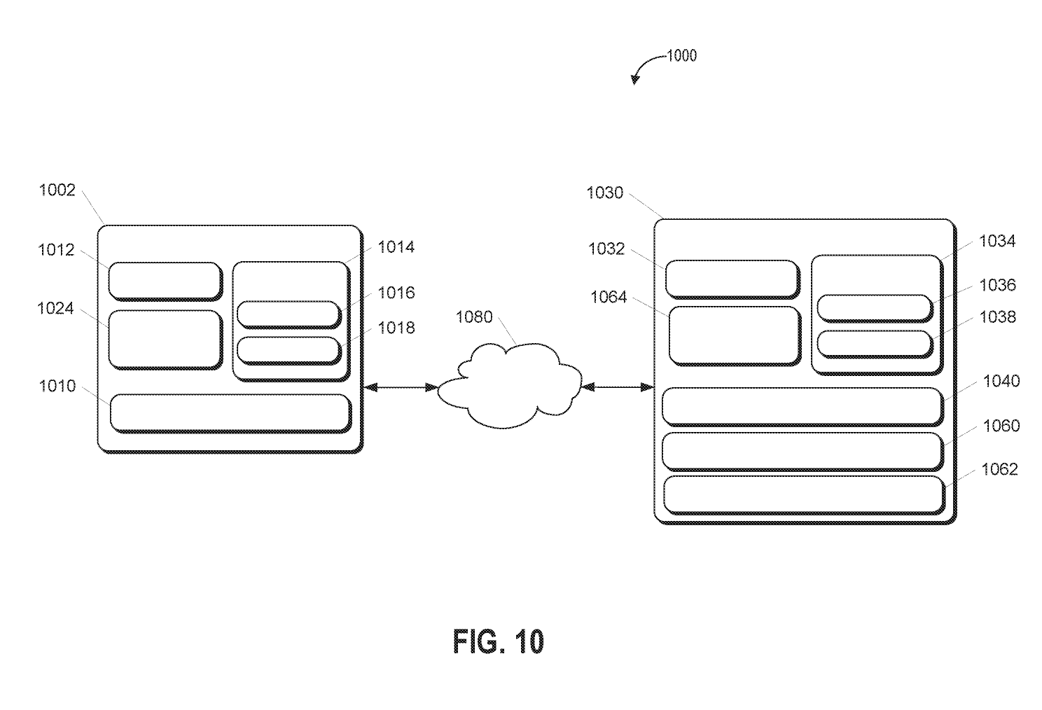

FIG. 10 depicts an example system 1000 according to example embodiments of the present disclosure. The example system 1000 includes a computing system 1002 and a machine learning computing system 1030 that are communicatively coupled (e.g., configured to send and/or receive signals and/or data) over network(s) 1080.

In some implementations, the computing system 1002 can perform various operations including the determination of an object's physical dimensions and/or orientation. In some implementations, the computing system 1002 can be included in an autonomous vehicle. For example, the computing system 1002 can be on-board the autonomous vehicle. In other implementations, the computing system 1002 is not located on-board the autonomous vehicle. For example, the computing system 1002 can operate offline to determine the physical dimensions and/or orientations of objects. The computing system 1002 can include one or more distinct physical computing devices.

The computing system 1002 includes one or more processors 1012 and a memory 1014. The one or more processors 1012 can be any suitable processing device (e.g., a processor core, a microprocessor, an ASIC, a FPGA, a controller, a microcontroller, etc.) and can be one processor or a plurality of processors that are operatively connected. The memory 1014 can include one or more non-transitory computer-readable storage media, such as RAM, ROM, EEPROM, EPROM, one or more memory devices, flash memory devices, etc., and combinations thereof.

The memory 1014 can store information that can be accessed by the one or more processors 1012. For instance, the memory 1014 (e.g., one or more non-transitory computer-readable storage mediums, memory devices) can store data 1016 that can be obtained, received, accessed, written, manipulated, created, and/or stored. The data 1016 can include, for instance, include examples as described herein. In some implementations, the computing system 1002 can obtain data from one or more memory device(s) that are remote from the computing system 1002.

The memory 1014 can also store computer-readable instructions 1018 that can be executed by the one or more processors 1012. The instructions 1018 can be software written in any suitable programming language or can be implemented in hardware. Additionally, or alternatively, the instructions 1018 can be executed in logically and/or virtually separate threads on processor(s) 1012.

For example, the memory 1014 can store instructions 1018 that when executed by the one or more processors 1012 cause the one or more processors 1012 to perform any of the operations and/or functions described herein, including, for example, insert functions.

According to an aspect of the present disclosure, the computing system 1002 can store or include one or more machine learned models 1010. As examples, the machine learned models 1010 can be or can otherwise include various machine learned models such as, for example, neural networks (e.g., deep neural networks), support vector machines, decision trees, ensemble models, k-nearest neighbors models, Bayesian networks, logistic regression classification, boosted forest classification, or other types of models including linear models and/or non-linear models. Example neural networks include feed-forward neural networks, recurrent neural networks (e.g., long short-term memory recurrent neural networks), or other forms of neural networks.

In some implementations, the computing system 1002 can receive the one or more machine learned models 1010 from the machine learning computing system 1030 over network 1080 and can store the one or more machine learned models 1010 in the memory 1014. The computing system 1002 can then use or otherwise implement the one or more machine learned models 1010 (e.g., by processor(s) 1012). In particular, the computing system 1002 can implement the machine learned model(s) 1010 to determine the physical dimensions and orientations of objects.

The machine learning computing system 1030 includes one or more processors 1032 and a memory 1034. The one or more processors 1032 can be any suitable processing device (e.g., a processor core, a microprocessor, an ASIC, a FPGA, a controller, a microcontroller, etc.) and can be one processor or a plurality of processors that are operatively connected. The memory 1034 can include one or more non-transitory computer-readable storage media, such as RAM, ROM, EEPROM, EPROM, one or more memory devices, flash memory devices, etc., and combinations thereof.

The memory 1034 can store information that can be accessed by the one or more processors 1032. For instance, the memory 1034 (e.g., one or more non-transitory computer-readable storage mediums, memory devices) can store data 1036 that can be obtained, received, accessed, written, manipulated, created, and/or stored. The data 1036 can include, for instance, include examples as described herein. In some implementations, the machine learning computing system 1030 can obtain data from one or more memory device(s) that are remote from the machine learning computing system 1030.

The memory 1034 can also store computer-readable instructions 1038 that can be executed by the one or more processors 1032. The instructions 1038 can be software written in any suitable programming language or can be implemented in hardware. Additionally, or alternatively, the instructions 1038 can be executed in logically and/or virtually separate threads on processor(s) 1032.

For example, the memory 1034 can store instructions 1038 that when executed by the one or more processors 1032 cause the one or more processors 1032 to perform any of the operations and/or functions described herein, including, for example, insert functions.

In some implementations, the machine learning computing system 1030 includes one or more server computing devices. If the machine learning computing system 1030 includes multiple server computing devices, such server computing devices can operate according to various computing architectures, including, for example, sequential computing architectures, parallel computing architectures, or some combination thereof.

In addition or alternatively to the model(s) 1010 at the computing system 1002, the machine learning computing system 1030 can include one or more machine learned models 1040. As examples, the machine learned models 1040 can be or can otherwise include various machine learned models such as, for example, neural networks (e.g., deep neural networks), support vector machines, decision trees, ensemble models, k-nearest neighbors models, Bayesian networks, logistic regression classification, boosted forest classification, or other types of models including linear models and/or non-linear models. Example neural networks include feed-forward neural networks, recurrent neural networks (e.g., long short-term memory recurrent neural networks, or other forms of neural networks.

As an example, the machine learning computing system 1030 can communicate with the computing system 1002 according to a client-server relationship. For example, the machine learning computing system 1030 can implement the machine learned models 1040 to provide a web service to the computing system 1002. For example, the web service can provide results including the physical dimensions and/or orientations of objects.

Thus, machine learned models 1010 can be located and used at the computing system 1002 and/or machine learned models 1040 can be located and used at the machine learning computing system 1030.

In some implementations, the machine learning computing system 1030 and/or the computing system 1002 can train the machine learned models 1010 and/or 1040 through use of a model trainer 1060. The model trainer 1060 can train the machine learned models 1010 and/or 1040 using one or more training or learning algorithms. One example training technique is backwards propagation of errors. In some implementations, the model trainer 1060 can perform supervised training techniques using a set of labeled training data. In other implementations, the model trainer 1060 can perform unsupervised training techniques using a set of unlabeled training data. The model trainer 1060 can perform a number of generalization techniques to improve the generalization capability of the models being trained. Generalization techniques include weight decays, dropouts, or other techniques.

In particular, the model trainer 1060 can train a machine learned model 1010 and/or 1040 based on a set of training data 1062. The training data 1062 can include, for example, various features of one or more objects. The model trainer 1060 can be implemented in hardware, firmware, and/or software controlling one or more processors.

The computing system 1002 can also include a network interface 1024 used to communicate with one or more systems or devices, including systems or devices that are remotely located from the computing system 1002. The network interface 1024 can include any circuits, components, software, etc. for communicating with one or more networks (e.g., the network(s) 1080). In some implementations, the network interface 1024 can include, for example, one or more of a communications controller, receiver, transceiver, transmitter, port, conductors, software and/or hardware for communicating data. Further, the machine learning computing system 1030 can include a network interface 1064.

The network(s) 1080 can include any type of network or combination of networks that allows for communication between devices. In some embodiments, the network(s) can include one or more of a local area network, wide area network, the Internet, secure network, cellular network, mesh network, peer-to-peer communication link and/or some combination thereof and can include any number of wired or wireless links. Communication over the network(s) 1080 can be accomplished, for instance, via a network interface using any type of protocol, protection scheme, encoding, format, and/or packaging.

FIG. 10 illustrates one example computing system 1000 that can be used to implement the present disclosure. Other computing systems can be used as well. For example, in some implementations, the computing system 1002 can include the model trainer 1060 and the training dataset 1062. In such implementations, the machine learned models 1010 can be both trained and used locally at the computing system 1002. As another example, in some implementations, the computing system 1002 is not connected to other computing systems.

In addition, components illustrated and/or discussed as being included in one of the computing systems 1002 or 1030 can instead be included in another of the computing systems 1002 or 1030. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method of operating an autonomous vehicle, the computer-implemented method comprising:
receiving, by a computing system comprising one or more computing devices, object data based in part on one or more states of one or more objects, wherein the object data comprises information based in part on sensor output associated with one or more portions of the one or more objects that is detected by one or more sensors of the autonomous vehicle;
determining, by the computing system, based in part on the object data and a machine learned model, one or more characteristics of the one or more objects, the one or more characteristics comprising an estimated set of physical dimensions of the one or more objects;
determining, by the computing system, based in part on the estimated set of physical dimensions of the one or more objects, one or more orientations corresponding to the one or more objects, wherein the one or more orientations are relative to a location of the autonomous vehicle; and
activating, by the computing system, based in part on the one or more orientations of the one or more objects, one or more vehicle systems associated with the autonomous vehicle.

2. The computer-implemented method of claim 1, wherein the one or more sensors are configured to detect a plurality of three-dimensional positions of surfaces of the one or more objects, the sensor output from the one or more sensors comprising one or more three-dimensional points associated with the plurality of three-dimensional positions of the surfaces of the one or more objects.

3. The computer-implemented method of claim 2, wherein the one or more sensors comprises one or more light detection and ranging devices (LIDAR), one or more radar devices, one or more sonar devices, or one or more cameras.

4. The computer-implemented method of claim 1, further comprising:
generating, by the computing system, based in part on the object data and the machine learned model, one or more bounding shapes that surround one or more areas associated with the estimated set of physical dimensions of the one or more objects, the one or more bounding shapes comprising one or more polygons, wherein the one or more orientations of the one or more objects are based in part on characteristics of the one or more bounding shapes, the characteristics comprising a length, a width, a height, or a center-point associated with the one or more bounding shapes.

5. The computer-implemented method of claim 1, further comprising:
determining, by the computing system, based in part on the object data and the machine learned model, the one or more portions of the one or more objects that are occluded by at least one other object of the one or more objects, wherein the estimated set of physical dimensions for the one or more objects is based in part on the one or more portions of the one or more objects that are not occluded by at least one other object of the one or more objects.

6. The computer-implemented method of claim 1, further comprising:
generating, by the computing system, the machine learned model based in part on a plurality of classified features and classified object labels associated with training data, the plurality of classified features extracted from point cloud data comprising a plurality of three-dimensional points associated with optical sensor output from one or more optical sensor devices comprising one or more light detection and ranging (LIDAR) devices.

7. The computer-implemented method of claim 6, wherein the machine learned model is based in part on one or more classification techniques comprising a random forest classifier, gradient boosting, a neural network, a support vector machine, a logistic regression classifier, or a boosted forest classifier.

8. The computer-implemented method of claim 6, wherein the plurality of classified features comprises a range of velocities associated with the plurality of training objects, a range of accelerations associated with the plurality of training objects, a length of the plurality of training objects, a width of the plurality of training objects, or a height of the plurality of training objects.

9. The computer-implemented method of claim 6, wherein the one or more classified object labels comprises pedestrians, vehicles, or cyclists.

10. The computer-implemented method of claim 6, further comprising:
determining, by the computing system, for each of the one or more objects, based in part on a comparison of the one or more characteristics of the one or more objects to the plurality of classified features associated with the plurality of training objects, one or more shapes corresponding to the one or more objects, wherein the one or more orientations of the one or more objects is based in part on the one or more shapes of the one or more objects.

11. The computer-implemented method of claim 1, further comprising:
determining, by the computing system, based in part on the one or more characteristics of the one or more objects, one or more states of the one or more objects over a plurality of time periods; and
determining, by the computing system, one or more estimated states of the one or more objects based in part on changes in the one or more states of the one or more objects over a set of the plurality of time periods, wherein the one or more orientations of the one or more objects are based in part on the one or more states of the one or more objects.

12. The computer-implemented method of claim 11, wherein the one or more estimated states of the one or more objects over the set of the plurality of time periods comprises one or more travel paths of the one or more objects and further comprising:
determining, by the computing system, based in part on the one or more travel paths of the one or more objects, a vehicle travel path for the autonomous vehicle in which the autonomous vehicle does not intersect the one or more objects, wherein the activating, by the computing system, one or more vehicle systems associated with the autonomous vehicle is based in part on the vehicle travel path.

13. The computer-implemented method of claim 11, wherein the one or more estimated states of the one or more objects over the set of the plurality of time periods comprises one or more locations of the one or more objects over the set of the plurality of time periods, the estimated set of physical dimensions of the one or more objects over the set of the plurality of time periods, or one or more classified object labels associated with the one or more objects over the set of the plurality of time periods.

14. One or more tangible, non-transitory computer-readable media storing computer-readable instructions that when executed by one or more processors cause the one or more processors to perform operations, the operations comprising:
receiving object data based in part on one or more states of one or more objects, wherein the object data comprises information based in part on sensor output associated with one or more portions of the one or more objects that is detected by one or more sensors of an autonomous vehicle;
determining, based in part on the object data and a machine learned model, one or more characteristics of the one or more objects, the one or more characteristics comprising an estimated set of physical dimensions of the one or more objects;
determining, by the one or more processors, based in part on the estimated set of physical dimensions of the one or more objects, one or more orientations corresponding to the one or more objects, wherein the one or more orientations are relative to a location of the autonomous vehicle; and
activating, based in part on the one or more orientations of the one or more objects, one or more vehicle systems associated with the autonomous vehicle.

15. The one or more tangible, non-transitory computer-readable media of claim 14, further comprising:
generating, based in part on the object data and the machine learned model, one or more bounding shapes that surround one or more areas associated with the estimated set of physical dimensions of the one or more objects, the one or more bounding shapes comprising one or more polygons, wherein the one or more orientations of the one or more objects are based in part on characteristics of the one or more bounding shapes, the characteristics comprising a length, a width, a height, or a center-point associated with the one or more bounding shapes.

16. The one or more tangible, non-transitory computer-readable media of claim 14, further comprising:
generating the machine learned model based in part on a plurality of classified features and classified object labels associated with training data, the plurality of classified features extracted from point cloud data comprising a plurality of three-dimensional points associated with optical sensor output from one or more optical sensor devices comprising one or more light detection and ranging (LIDAR) devices.

17. A computing system comprising:
one or more processors;
a memory comprising one or more computer-readable media, the memory storing computer-readable instructions that when executed by the one or more processors cause the one or more processors to perform operations comprising:
receiving object data based in part on one or more states of one or more objects, wherein the object data comprises information based in part on sensor output associated with one or more portions of the one or more objects that is detected by one or more sensors of an autonomous vehicle;
determining, based in part on the object data and a machine learned model, one or more characteristics of the one or more objects, the one or more characteristics comprising an estimated set of physical dimensions for the one or more objects;
determining, based in part on the estimated set of physical dimensions of the one or more objects, one or more orientations corresponding to the one or more objects, wherein the one or more orientations are relative to a location of the autonomous vehicle; and
activating, based in part on the one or more orientations of the one or more objects, one or more vehicle systems associated with the autonomous vehicle.

18. The computing system of claim 17, further comprising:
determining, based in part on the one or more characteristics of the one or more objects, one or more states of the one or more objects over a plurality of time periods; and
determining one or more estimated states of the one or more objects based in part on changes in the one or more states of the one or more objects over a predetermined set of the plurality of time periods, the one or more estimated states of the one or more objects comprising one or more locations of the one or more objects, wherein the one or more orientations of the one or more objects are based in part on the one or more states of the one or more objects.

19. The computing system of claim 17, further comprising:
generating, based in part on the object data and the machine learned model, one or more bounding shapes that surround one or more areas associated with the estimated set of physical dimensions of the one or more objects, the one or more bounding shapes comprising one or more polygons, wherein the one or more orientations of the one or more objects are based in part on characteristics of the one or more bounding shapes, the characteristics comprising a length, a width, a height, or a center-point associated with the one or more bounding shapes.

20. The computing system of claim 17, further comprising:
generating the machine learned model based in part on a plurality of classified features and classified object labels associated with training data, the plurality of classified features extracted from point cloud data comprising a plurality of three-dimensional points associated with optical sensor output from one or more optical sensor devices comprising one or more light detection and ranging (LIDAR) devices.
